(19) United States
(12) Patent Application Publication
(10) Pub. No.: US 2023/0212483 A1
(43) Pub. Date: Jul. 6, 2023

(54) Improvements in or Relating to Organic Compounds

(71) Applicant: GIVAUDAN SA, VERNIER (CH)

(72) Inventor: Jeremy COMPTON, Kloten (CH)

(21) Appl. No.: 18/007,584

(22) PCT Filed: Jul. 20, 2021
(86) PCT No.: PCT/EP2021/070199

§ 371 Date: Dec. 1, 2022

(30) Foreign Application Priority Data
Jul. 29, 2020 (GB) 2011735.4

(51) Int. Cl. C11D 3/50; B01J 13/10; B01J 13/14

(52) U.S. Cl. CPC C11D 3/505; B01J 13/10; B01J 13/14

(57) ABSTRACT

Disclosed is an encapsulated composition comprising a plurality of core-shell microcapsules. The core-shell microcapsules comprise a core and a shell surrounding the core. The core comprises a perfume composition comprising at least one biodegradable ingredient(s). The biodegradable ingredient(s) is/are present at a total concentration of at least 75 wt.-% relative to the total weight of the perfume composition.

The present invention relates to encapsulated compositions comprising a plurality of core-shell microcapsules and to a use of such encapsulated compositions for obtaining a consumer product.

It is known to incorporate encapsulated functional materials in consumer products, such as household care, personal care and fabric care products. Functional materials include for example fragrances, cosmetic actives, and biologically active ingredients, such as biocides and drugs.

Microcapsules that are particularly suitable for delivery of such functional materials are core-shell microcapsules, wherein the core comprises the functional material and the shell is impervious or partially impervious to the functional material. Usually, these microcapsules are used in aqueous media and the encapsulated functional materials are hydrophobic. A broad selection of shell materials can be used provided this shell material is impervious or partially impervious to the encapsulated functional material.

Among the functional materials, fragrances are encapsulated for a variety of reasons. Microcapsules can isolate and protect the fragrances from external suspending media, such as consumer product bases, with which they may be incompatible or unstable in. They are also used to assist in the deposition of fragrance ingredients onto substrates, such as skin, hair, fabrics or hard household surfaces. They can also act as a means of controlling the spatio-temporal release of the fragrance.

Thermosetting resins are common encapsulating materials for encapsulating functional materials, especially volatile functional materials, such as fragrance ingredients. Core-shell microcapsules formed from aminoplast resins, polyurea resins, polyurethane resins, polyacrylate resin, and combinations thereof are generally quite resistant to fragrance leakage when dispersed in aqueous suspending media, even in surfactant-containing media. When incorporated into consumer products, such as laundry detergents or conditioners, they provide perfumery benefits that are unattainable if perfume is incorporated directly into those products.

Furthermore, since nowadays consumers are more aware of environmental and resource protection, core-shell microcapsules based on bio-sourced materials have recently been developed. Such capsules have a lower ecological footprint and allow for the encapsulation of functional materials with high efficiency and exhibit the required release properties.

However, despite those advances, there is still a need to provide core-shell fragrance microcapsules showing improved overall sustainability.

This problem is solved by the subject-matter of the independent claims.

The present invention relates to an encapsulated composition comprising a plurality of core-shell microcapsules. The core-shell microcapsules comprise a core and a shell surrounding the core. The core comprises, preferably consists of, a perfume composition comprising, preferably consisting of, at least one, preferably at least two, more preferably at least four, even more preferably at least eight, even still more preferably at least 16, even still further more preferably at least 32, even yet still further more preferably at least 64, biodegradable ingredient(s). The biodegradable ingredient(s) is/are present at a total concentration of at least 75 wt.-%, preferably at least 80 wt.-%, more preferably at least 85 wt.-%, even more preferably at least 90 wt.-%, even still more preferably at least 95 wt.-%, relative to the total weight of the perfume composition.

In context of the present invention, a “biodegradable ingredient” is an ingredient which meets the pass criteria for “inherently biodegradable” and/or “readily biodegradable” in at least one OECD biodegradation study. In order to avoid any ambiguity, this means that if an ingredient passes one test but fails one or more other ones, the pass result overrules the other test results.

“Ultimate biodegradability” refers to the complete breakdown of a chemical into water, carbon dioxide and new biomass.

For assessment of the pass criteria for “readily biodegradable”, the biodegradation study can be selected from the group consisting of OECD Method 301C, OECD Method 301D, OECD Method 301F and OECD Method 310. These methods are suitable for volatile materials.

OECD Method 301C, OECD Method 301D and OECD Method 301F are described in the OECD Guidelines for the Testing of Chemicals, Section 3, Test No. 301: Ready Biodegradability (Adopted: 17 Jul. 1992; https://doi.org/10.1787/97892640703-(9-en).

OECD Method 310 is described in the OECD Guidelines for the Testing of Chemicals, Section 3, Test No. 310: Ready Biodegradability—CO₂ in sealed vessels (Headspace Test) (Adopted: 23 Mar. 2006; Corrected: 26 Sep. 2014; https://doi.org/10.1787/9789264016316-en).

In a particular aspect of the present invention, the pass criteria for “readily biodegradable” are assessed according to OECD Method 301F, which refers to manometric respirometry. In this method the pass level for “ready biodegradability” is to reach 60% of theoretical oxygen demand and/or chemical oxygen demand. This pass value has to be reached in a 10-day window within the 28-day period of the test. The 10-day window begins when the degree of biodegradation has reached 10% of theoretical oxygen demand and/or chemical oxygen demand and must end before day 28 of the test.

Given a positive result in a test of ready biodegradability, it may be assumed that the chemical will undergo rapid and ultimate biodegradation in the environment (Introduction to the OECD Guidelines for the Testing of Chemicals, Section 3, Part 1: Principles and Strategies Related to the Testing of Degradation of Organic Chemicals; Adopted: July 2003).

For assessment of the pass criteria for “inherently biodegradable”, the biodegradation study can be OECD Method 302C, but also OECD Method 301F can be used, although with different pass criteria. Also these methods are suitable for volatile materials.

OECD Method 302C is described in the OECD Guidelines for the Testing of Chemicals, Section 3, Test No. 302C: Inherent Biodegradability: Modified MITI Test (II) (Adopted: 12 May 1981; Corrected 8 Sep. 2009; https://doi.org/10.1787/9789264070400-en).

In a particular aspect of the present invention, the pass criteria for “inherently biodegradable” are assessed by OECD Method 302C. In this method the pass level for “inherently biodegradability” is then to reach 70% of theoretical oxygen demand. There is no time limit to reach this level.

Biodegradation rates above 70% may be regarded as evidence of inherent, ultimate biodegradability (OECD Guidelines for the Testing of Chemicals, Section 3, Part 1: Principles and Strategies Related to the Testing of Degradation of Organic Chemicals; Adopted: July 2003).

If OECD Method 301F is used for assessment of the pass criteria for “inherently biodegradable”, the pass level is 60% of theoretical oxygen demand and/or chemical oxygen demand. This pass value can be reached after the 28-day period of the test, which is usually extended to 60 days. No 10-day window applies.

In the present context, if an ingredient is an essential oil, it is considered to be a “biodegradable ingredient” if all of its constituents present at a level ≥1 wt.-% fall under the definition of “inherently biodegradable” and/or “readily biodegradable” as defined herein above. However, the essential oil can also be subjected to the above-mentioned biodegradation tests.

Perfume core-shell microcapsules typically have a core to shell weight ratio of 6:4 or more, meaning that the overwhelming majority the capsule mass consist of core material. As a consequence of this, the overall ecological footprint of the capsule can be significantly improved—independent of the shell material—by using biodegradable ingredient(s) as core materials. Biodegradation is the key process for removal of perfume ingredients in the environment.

In a particular embodiment of the present invention, the biodegradable ingredient(s) is/are selected from the group consisting of ACETYL ISOEUGENOL ((E)-2-methoxy-4-(prop-1-en-1-yl)phenyl acetate); ADOXAL (2,6,10-trimethylundec-9-enal); AGRUMEX (2-(tert-butyl)cyclohexyl acetate); ALDEHYDE C 10 DECYLIC (decanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA (2-methylundecanal); ALDEHYDE C 8 OCTYLIC (octanal); CYCLAMEN ALDEHYDE EXTRA (3-(4-isopropylphenyl)-2-methylpropanal); ALDEHYDE ISO C 11 ((E)-undec-9-enal); ALLYL AMYL GLYCOLATE (prop-2-enyl 2-(3-methylbutoxy)acetate); ALLYL CYCLOHEXYL PROPIONATE (prop-2-enyl 3-cyclohexylpropanoate); ALLYL OENANTHATE (prop-2-enyl heptanoate); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL SALICYLATE (pentyl 2-hydroxybenzoate); AUBEPINE PARA CRESOL (4-methoxybenzaldehyde); BENZYL ACETATE (benzyl acetate); BENZYL SALICYLATE (benzyl 2-hydroxybenzoate); BORNYL ACETATE ((2S,4S)-1,7,7-trimethylbicyclo[2.2.1]heptan-2-yl acetate); CARVACROL (5-isopropyl-2-methylphenol); CEDRENE ((1S,8aR)-1,4,4,6-tetramethyl-2,3,3a,4,5,8-hexahydro-1H-5,8a-methanoazulene); CEDRYL ACETATE ((1S,6R,8aR)-1,4,4,6-tetramethyloctahydro-1H-5,8a-methanoazulen-6-yl acetate); CEDRYL METHYL ETHER ((1R,6S,8aS)-6-methoxy-1,4,4,6-tetramethyloctahydro-1H-5,8a-methanoazulene); CITRAL ((E)-3,7-dimethylocta-2,6-dienal); CITRONELLOL (3,7-dimethyloct-6-en-1-ol); CITRONELLYL ACETATE (3,7-dimethyloct-6-en-1-yl acetate); COSMONE ((Z)-3-methylcyclotetradec-5-enone); CRESYL METHYL ETHER PARA (1-methoxy-4-methylbenzene); CYCLOHEXYL ETHYL ACETATE (2-cyclohexylethyl acetate); CYCLOHEXYL SALICYLATE (cyclohexyl 2-hydroxybenzoate); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DECALACTONE GAMMA (5-hexyloxolan-2-one); DECENAL-4-TRANS ((E)-dec-4-enal); DIHYDRO MYRCENOL (2,6-dimethyloct-7-en-2-ol); DIPHENYL OXIDE (oxydibenzene); DIHYDRO ANETHOLE (1-methoxy-4-propylbenzene); DIHYDRO JASMONE (3-methyl-2-pentylcyclopent-2-enone); DIMETHYL ANTHRANILATE (methyl 2-(methylamino)benzoate); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETOL (2,6-dimethylheptan-2-ol); DODECALACTONE DELTA (6-heptyltetrahydro-2H-pyran-2-one); DODECALACTONE GAMMA (5-octyloxolan-2-one); DODECENAL ((E)-dodec-2-enal); EBANOL ((E)-3-methyl-5-(2,2,3-trimethylcyclopent-3-en-1-yl)pent-4-en-2-ol); ETHYL HEXANOATE (ethyl hexanoate); ETHYL METHYL-2-BUTYRATE (ethyl 2-methyl butyrate); ETHYL MALTOL (2-ethyl-3-hydroxy-4H-pyran-4-one); ETHYL OENANTHATE (ethyl heptanoate); ETHYL VANILLIN (3-ethoxy-4-hydroxybenzaldehyde); ETHYLENE BRASSYLATE (1,4-dioxacycloheptadecane-5,17-dione); EUCALYPTOL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FIXAMBRENE (3a,6,6,9a-tetramethyldodecahydronaphtho[2,1-b]furan); FLORHYDRAL (3-(3-isopropylphenyl)butanal); FLORIDILE ((E)-undec-9-enenitrile); GALBANONE PURE (1-(5,5-dimethylcyclohex-1-en-1-yl)pent-4-en-1-one); GARDENOL (1-phenylethyl acetate); GERANIOL ((E)-3,7-dimethylocta-2,6-dien-1-ol); GERANYL ACETATE ((E)-3,7-dimethylocta-2,6-dien-1-yl acetate); HABANOLIDE ((E)-oxacyclohexadec-12-en-2-one); HEDIONE (methyl 3-oxo-2-pentylcyclopentaneacetate); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS SALICYLATE ((Z)-hex-3-en-1-yl 2-hydroxybenzoate); HEXYL ACETATE (hexyl acetate); INDOLENE (8,8-di(1H-indol-3-yl)-2,6-dimethyloctan-2-ol); IONONE BETA ((E)-4-(2,6,6-trimethylcyclohex-1-en-1-yl)but-3-en-2-one); IRISANTHEME ((E)-3-methyl-4-(2,6,6-trimethylcyclohex-2-en-1-yl)but-3-en-2-one); IRISONE ALPHA ((E)-4-(2,6,6-trimethylcyclohex-2-en-1-yl)but-3-en-2-one); ISOAMYL ACETATE (3-methylbutyl acetate); ISOAMYL BUTYRATE (3-methylbutyl butanoate); ISOEUGENOL ((E)-2-methoxy-4-(prop-1-en-1-yl)phenol); ISOJASMONE B 11 (2-hexylcyclopent-2-en-1-one); ISORALDEINE ((E)-3-methyl-4-(2,6,6-trimethylcyclohex-2-en-1-yl)but-3-en-2-one); JASMONYL (3-butyl-5-methyltetrahydro-2H-pyran-4-yl acetate); LAITONE (8-isopropyl-1-oxaspiro[4.5]decan-2-one); LEMONILE ((2E,6Z)-3,7-dimethylnona-2,6-dienenitrile); LINALOOL (3,7-dimethylocta-1,6-dien-3-ol); LINALOOL OXIDE (2-(5-methyl-5-vinyltetrahydrofuran-2-yl)propan-2-ol); LINALYL ACETATE (3,7-dimethylocta-1,6-dien-3-yl acetate); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); MERCAPTO-8-METHANE-3-ONE (mercapto-para-menthan-3-one); METHYL ANTHRANILATE (methyl 2-aminobenzoate); METHYL BENZOATE (methyl benzoate); METHYL DIANTILIS (2-ethoxy-4-(methoxymethyl)phenol); METHYL HEPTENONE PURE (6-methylhept-5-en-2-one); METHYL LAITONE (8-methyl-1-oxaspiro[4.5]decan-2-one); METHYL OCTYNE CARBONATE (methyl non-2-ynoate); METHYL SALICYLATE (methyl 2-hydroxybenzoate); NECTARYL (2-(2-(4-methylcyclohex-3-en-1-yl)propyl)cyclopentanone); NEOFOLIONE ((E)-methyl non-2-enoate); NEROLEX ((2Z)-3,7-dimethylocta-2,6-dien-1-ol); NEROLIDOL ((Z)-3,7,11-trimethyldodeca-1,6,10-trien-3-ol); NEROLINE CRYSTALS (2-ethoxynaphthalene); NEROLIONE (1-(3-methylbenzofuran-2-yl)ethanone); NERYL ACETATE ((Z)-3,7-dimethylocta-2,6-dien-1-yl acetate); NONADIENAL ((2E,6Z)-nona-2,6-dienal); NONENAL-6-CIS ((Z)-non-6-enal); NONENOL-6-CIS ((Z)-non-6-en-1-ol); NYMPHEAL (3-(4-(2-methylpropyl)-2-methylphenyl)propanal); OCTALACTONE DELTA (6-propyltetrahydro-2H-pyran-2-one); ORANGER CRYSTALS (1-(2-naphtalenyl)-ethanone); PARA TERT BUTYL CYCLOHEXYL ACETATE (4-(tert-butyl)cyclohexyl acetate); PEACH PURE (5-heptyldihydrofuran-2(3H)-one); PELARGOL (3,7-dimethyloctan-1-ol); PHENYL ETHYL ACETATE (2-phenylethyl acetate); PINENE ALPHA (2,6,6-trimethylbicyclo[3.1.1]hept-2-ene); PINENE BETA (6,6-dimethyl-2-methylenebicyclo[3.1.1]heptane); POMAROSE ((2E,5E)-5,6,7-trimethylocta-2,5-dien-4-one); POMELOL FF (2,4,7-Trimethyl-6-octen-1-ol); PRENYL ACETATE (3-methylbut-2-en-1-yl acetate); PRUNOLIDE (5-pentyldihydrofuran-2(3H)-one); RASPBERRY KETONE (4-(4-hydroxyphenyl)butan-2-one); ROSALVA (dec-9-en-1-ol); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SAFRANAL (2,6,6-trimethylcyclohexa-1,3-dienecarbaldehyde); SCENTAURUS JUICY (4-(dodecylthio)-4-methylpentan-2-one); SILVIAL (2-methyl-3-[4-(2-methylpropyl)phenyl]propanal); STYRALLYL ACETATE (1-phenylethyl acetate); SYLKOLIDE ((E)-2-((3,5-dimethylhex-3-en-2-yl)oxy)-2-methylpropyl cyclopropanecarboxylate); TERPINENE GAMMA (1-methyl-4-propan-2-ylcyclohexa-1,4-diene); TERPINEOL (2-(4-methylcyclohex-3-en-1-yl)propan-2-ol); TERPINOLENE (1-methyl-4-(propan-2-ylidene)cyclohex-1-ene); TETRAHYDRO LINALOOL (3,7-dimethyloctan-3-ol); TOSCANOL (1-(cyclopropylmethyl)-4-methoxybenzene); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); UNDECAVERTOL ((E)-4-methyldec-3-en-5-ol); YARA YARA (2-methoxynaphtalene); BOIS CEDRE ESS CHINE (cedar wood oil); EUCALYPTUS GLOBULUS ESS CHINA (eucalyptus oil); GALBANUM ESS (galbanum oil); GIROFLE FEUILLES ESS RECT MADAGASCAR (clove oil); LAVANDIN GROSSO OIL FRANCE ORPUR (lavandin oil); MANDARIN OIL WASHED COSMOS (mandarin oil); ORANGE TERPENES (orange terpenes); PATCHOULI ESS INDONESIE (patchouli oil); and YLANG ECO ESSENCE (ylang oil).

The above-mentioned ingredients have all been identified as not only fulfilling at least one of the aforementioned biodegradability criteria, but also as being suitable for encapsulation with respect to their physical and chemical properties, such as lipophilicity, molecular size and reactivity towards shell materials. They therefore provide a useful selection of perfume ingredients for readily and reliably providing more sustainable fragrance encapsulates.

In an encapsulated composition according to the present invention, each of the biodegradable ingredient(s) is preferably present at a concentration equal to or less than the following maximum concentrations:

(E)-2-methoxy-4-(prop-1-en-1-yl)phenyl acetate: 0.1 wt.-%

2,6,10-trimethylundec-9-enal: 1 wt.-%

2-(tert-butyl)cyclohexyl acetate: 50 wt.-%

decanal: 10 wt.-%

undec-10-enal: 2 wt.-%

undecanal: 5 wt.-%

dodecanal: 10 wt.-%

2-methylundecanal: 50 wt.-%

octanal: 5 wt.-%

3-(4-isopropylphenyl)-2-methylpropanal: 5 wt.-%

(E)-undec-9-enal: 5 wt.-%

prop-2-enyl 2-(3-methylbutoxy)acetate: 5 wt.-%

prop-2-enyl 3-cyclohexylpropanoate: 10 wt.-%

prop-2-enyl heptanoate: 10 wt.-%

(Z)-oxacycloheptadec-10-en-2-one: 2 wt.-%

(3aR,5aS,9aS,9bR)-3a,6,6,9a-tetramethyl-2,4,5,5a,7,8,9,9b-octahydro-1H-benzo[e][1]benzofuran: 2 wt.-%

pentyl 2-hydroxybenzoate: 50 wt.-%

4-methoxybenzaldehyde: 5 wt.-%

benzyl acetate: 10 wt.-%

benzyl 2-hydroxybenzoate: 75 wt.-%

(2S,4S)-1,7,7-trimethylbicyclo[2.2.1]heptan-2-yl acetate: 50 wt.-%

5-isopropyl-2-methylphenol: 1 wt.-%

(1S,8aR)-1,4,4,6-tetramethyl-2,3,3a,4,5,8-hexahydro-1H-5,8a-methanoazulene: 5 wt.-%

(1S,6R,8aR)-1,4,4,6-tetramethyloctahydro-1H-5,8a-methanoazulen-6-yl acetate: 5 wt.-%

(1R,6S,8aS)-6-methoxy-1,4,4,6-tetramethyloctahydro-1H-5,8a-methanoazulene: 5 wt.-%

(E)-3,7-dimethylocta-2,6-dienal: 10 wt.-%

3,7-dimethyloct-6-en-1-ol: 25 wt.-%

3,7-dimethyloct-6-en-1-yl acetate: 25 wt.-%

(Z)-3-methylcyclotetradec-5-enone: 5 wt.-%

1-methoxy-4-methylbenzene: 1 wt.-%

2-cyclohexylethyl acetate: 25 wt.-%

cyclohexyl 2-hydroxybenzoate: 15 wt.-%

(E)-1-(2,6,6-trimethylcyclohexa-1,3-dien-1-yl)but-2-en-1-one: 2.5 wt.-%

(E)-1-(2,6,6-trimethylcyclohex-2-en-1-yl)but-2-en-1-one: 5 wt.-%

5-hexyloxolan-2-one: 15 wt.-%

(E)-dec-4-enal: 1 wt.-%

2,6-dimethyloct-7-en-2-ol: 50 wt.-%

oxydibenzene: 15 wt.-%

1-methoxy-4-propylbenzene: 2 wt.-%

3-methyl-2-pentylcyclopent-2-enone: 5 wt.-%

methyl 2-(methylamino)benzoate: 1 wt.-%

2-methyl-1-phenylpropan-2-yl acetate: 75 wt.-%

2-methyl-1-phenylpropan-2-yl butanoate: 50 wt.-%

2,6-dimethylheptan-2-ol: 5 wt.-%

6-heptyltetrahydro-2H-pyran-2-one: 5 wt.-%

5-octyloxolan-2-one: 10 wt.-%

(E)-dodec-2-enal: 0.5 wt.-%

(E)-3-methyl-5-(2,2,3-trimethylcyclopent-3-en-1-yl)pent-4-en-2-ol: 5 wt.-%

ethyl hexanoate: 10 wt.-%

ethyl 2-methyl butyrate: 15 wt.-%

2-ethyl-3-hydroxy-4H-pyran-4-one: 10 wt.-%

ethyl heptanoate: 5 wt.-%

3-ethoxy-4-hydroxybenzaldehyde: 10 wt.-%

1,4-dioxacycloheptadecane-5,17-dione: 25 wt.-%

(1s,4s)-1,3,3-trimethyl-2-oxabicyclo[2.2.2]octane: 25 wt.-%

4-allyl-2-methoxyphenol: 5 wt.-%

methyl 2,4-dihydroxy-3,6-dimethylbenzoate: 2 wt.-%

3a,6,6,9a-tetramethyldodecahydronaphtho[2,1-b]furan: 2 wt.-%

3-(3-isopropylphenyl)butanal: 5 wt.-%

(E)-undec-9-enenitrile: 1 wt.-%

1-(5,5-dimethylcyclohex-1-en-1-yl)pent-4-en-1-one: 5 wt.-%

1-phenylethyl acetate: 5 wt.-%

(E)-3,7-dimethylocta-2,6-dien-1-ol: 25 wt.-%

(E)-3,7-dimethylocta-2,6-dien-1-yl acetate: 15 wt.-%

(E)-oxacyclohexadec-12-en-2-one: 15 wt.-%

methyl 3-oxo-2-pentylcyclopentaneacetate: 75 wt.-%

(E)-hex-2-enal: 1 wt.-%

(Z)-hex-3-en-1-ol: 15 wt.-%

(Z)-hex-3-en-1-yl acetate: 15 wt.-%

(Z)-hex-3-en-1-yl 2-hydroxybenzoate: 15 wt.-%

hexyl acetate: 15 wt.-%

8,8-di(1H-indol-3-yl)-2,6-dimethyloctan-2-ol: 2 wt.-%

(E)-4-(2,6,6-trimethylcyclohex-1-en-1-yl)but-3-en-2-one: 25 wt.-%

(E)-3-methyl-4-(2,6,6-trimethylcyclohex-2-en-1-yl)but-3-en-2-one: 5 wt.-%

(E)-4-(2,6,6-trimethylcyclohex-2-en-1-yl)but-3-en-2-one: 25 wt.-%

3-methylbutyl acetate: 5 wt.-%

3-methylbutyl butanoate: 1 wt.-%

(E)-2-methoxy-4-(prop-1-en-1-yl)phenol: 1 wt.-%

2-hexylcyclopent-2-en-1-one: 5 wt.-%

(E)-3-methyl-4-(2,6,6-trimethylcyclohex-2-en-1-yl)but-3-en-2-one: 50 wt.-%

3-butyl-5-methyltetrahydro-2H-pyran-4-yl acetate: 15 wt.-%

8-isopropyl-1-oxaspiro[4.5]decan-2-one: 1 wt.-%

(2E,6Z)-3,7-dimethylnona-2,6-dienenitrile: 25 wt.-%

3,7-dimethylocta-1,6-dien-3-ol: 25 wt.-%

2-(5-methyl-5-vinyltetrahydrofuran-2-yl)propan-2-ol: 1 wt.-%

3,7-dimethylocta-1,6-dien-3-yl acetate: 25 wt.-%

ethyl 2-methylpentanoate: 10 wt.-%

(4-isopropylcyclohexyl)methanol: 5 wt.-%

3-methyl-5-phenylpentan-1-ol: 10 wt.-%

2,6-dimethylhept-5-enal: 2 wt.-%

mercapto-para-menthan-3-one: 1 wt.-%

methyl 2-aminobenzoate: 2 wt.-%

methyl benzoate: 1 wt.-%

2-ethoxy-4-(methoxymethyl)phenol: 1 wt.-%

6-methylhept-5-en-2-one: 5 wt.-%

8-methyl-1-oxaspiro[4.5]decan-2-one: 2 wt.-%

methyl non-2-ynoate: 1 wt.-%

methyl 2-hydroxybenzoate: 1 wt.-%

2-(2-(4-methylcyclohex-3-en-1-yl)propyl)cyclopentanone: 50 wt.-%

(E)-methyl non-2-enoate: 2 wt.-%

(2Z)-3,7-dimethylocta-2,6-dien-1-ol: 10 wt.-%

(Z)-3,7,11-trimethyldodeca-1,6,10-trien-3-ol: 5 wt.-%

2-ethoxynaphthalene: 10 wt.-%

1-(3-methylbenzofuran-2-yl)ethanone: 5 wt.-%

(Z)-3,7-dimethylocta-2,6-dien-1-yl acetate: 5 wt.-%

(2E,6Z)-nona-2,6-dienal: 0.5 wt.-%

(Z)-non-6-enal: 0.5 wt.-%

(Z)-non-6-en-1-ol: 0.5 wt.-%

3-(4-(2-methylpropyl)-2-methylphenyl)propanal: 25 wt.-%

6-propyltetrahydro-2H-pyran-2-one: 1 wt.-%

1-(2-naphtalenyl)-ethanone: 10 wt.-%

4-(tert-butyl)cyclohexyl acetate: 50 wt.-%

5-heptyldihydrofuran-2(3H)-one: 25 wt.-%

3,7-dimethyloctan-1-ol: 10 wt.-%

2-phenylethyl acetate: 15 wt.-%

2,6,6-trimethylbicyclo[3.1.1]hept-2-ene: 2 wt.-%

6,6-dimethyl-2-methylenebicyclo[3.1.1]heptane: 2 wt.-%

(2E,5E)-5,6,7-trimethylocta-2,5-dien-4-one: 2 wt.-%

2,4,7-Trimethyl-6-octen-1-ol: 2 wt.-%

3-methylbut-2-en-1-yl acetate: 10 wt.-%

5-pentyldihydrofuran-2(3H)-one: 5 wt.-%

4-(4-hydroxyphenyl)butan-2-one: 5 wt.-%

dec-9-en-1-ol: 2 wt.-%

4-methyl-2-(2-methylprop-1-en-1-yl)tetrahydro-2H-pyran: 2 wt.-%

4-methyl-2-phenyl-3,6-dihydro-2H-pyran: 2 wt.-%

2,6,6-trimethylcyclohexa-1,3-dienecarbaldehyde: 0.5 wt.-%

4-(dodecylthio)-4-methylpentan-2-one: 0.5 wt.-%

2-methyl-3-[4-(2-methylpropyl)phenyl]propanal: 5 wt.-%

1-phenylethyl acetate: 5 wt.-%

(E)-2-((3,5-dimethylhex-3-en-2-yl)oxy)-2-methylpropyl

cyclopropanecarboxylate: 5 wt.-%

1-methyl-4-propan-2-ylcyclohexa-1,4-diene: 5 wt.-%

2-(4-methylcyclohex-3-en-1-yl)propan-2-ol: 5 wt.-%

1-methyl-4-(propan-2-ylidene)cyclohex-1-ene: 15 wt.-%

3,7-dimethyloctan-3-ol: 50 wt.-%

1-(cyclopropylmethyl)-4-methoxybenzene: 10 wt.-%

(E)-tridec-2-enenitrile: 15 wt.-%

3-phenylbutanal: 5 wt.-%

3-(benzo[d][1,3]dioxol-5-yl)-2-methylpropanal: 5 wt.-%

(E)-4-methyldec-3-en-5-ol: 25 wt.-%

2-methoxynaphtalene: 15 wt.-%

cedar wood oil: 5 wt.-%

eucalyptus oil: 25 wt.-%

galbanum oil: 2 wt.-%

clove oil: 5 wt.-%

lavandin oil: 25 wt.-%

mandarin oil: 5 wt.-%

orange terpenes: 50 wt.-%

patchouli oil: 10 wt.-%

ylang oil: 5 wt.-%

It has been found that keeping the concentrations below the provided maxima leads to improved results with regard to the olfactive perception of the perfume composition and its suitability for encapsulation.

In a preferred embodiment of the present invention, the perfume composition comprises, preferably consists of, at least one, preferably at least two, more preferably at least four, even more preferably at least six, biodegradable ingredient(s) selected from the group consisting of 2,6,10-trimethylundec-9-enal; 2-(tert-butyl)cyclohexyl acetate; 2-methylundecanal; prop-2-enyl 2-(3-methylbutoxy)acetate; prop-2-enyl 3-cyclohexylpropanoate; prop-2-enyl heptanoate; benzyl acetate; 3,7-dimethyloct-6-en-1-yl acetate; (E)-1-(2,6,6-trimethylcyclohexa-1,3-dien-1-yl)but-2-en-1-one; (E)-1-(2,6,6-trimethylcyclohex-2-en-1-yl)but-2-en-1-one; 5-hexyloxolan-2-one; 3-methyl-2-pentylcyclopent-2-enone; 2-methyl-1-phenylpropan-2-yl acetate; 2-methyl-1-phenylpropan-2-yl butanoate; 6-heptyltetrahydro-2H-pyran-2-one; 5-octyloxolan-2-one; ethyl hexanoate; ethyl 2-methyl butyrate; ethyl heptanoate; (Z)-hex-3-en-1-yl acetate; hexyl acetate; 3-methylbutyl acetate; 3-methylbutyl butanoate; 8-isopropyl-1-oxaspiro[4.5]decan-2-one; ethyl 2-methylpentanoate; mercapto-para-menthan-3-one; 6-methylhept-5-en-2-one; 8-methyl-1-oxaspiro[4.5]decan-2-one; 2-(2-(4-methylcyclohex-3-en-1-yl)propyl)cyclopentanone; (E)-methyl non-2-enoate; 6-propyltetrahydro-2H-pyran-2-one; 4-(tert-butyl)cyclohexyl acetate; 5-heptyldihydrofuran-2(3H)-one; (2E,5E)-5,6,7-trimethylocta-2,5-dien-4-one; 3-methylbut-2-en-1-yl acetate; 5-pentyldihydrofuran-2(3H)-one; 4-(4-hydroxyphenyl)butan-2-one; and 4-(dodecylthio)-4-methylpentan-2-one. Those ingredients are particularly suitable for providing a perfume with a fruity character.

In a preferred embodiment of the present invention, the perfume composition comprises, preferably consists of, at least one, preferably at least two, more preferably at least four, even more preferably at least six, biodegradable ingredient(s) selected from the group consisting of 3-(4-isopropylphenyl)-2-methylpropanal; (E)-undec-9-enal; pentyl 2-hydroxybenzoate; 4-methoxybenzaldehyde; benzyl acetate; 3,7-dimethyloct-6-en-1-ol; 3,7-dimethyloct-6-en-1-yl acetate; 1-methoxy-4-methylbenzene; 2-cyclohexylethyl acetate; cyclohexyl 2-hydroxybenzoate; (E)-1-(2,6,6-trimethylcyclohexa-1,3-dien-1-yl)but-2-en-1-one; (E)-1-(2,6,6-trimethylcyclohex-2-en-1-yl)but-2-en-1-one; 2,6-dimethyloct-7-en-2-ol; oxydibenzene; 3-methyl-2-pentylcyclopent-2-enone; methyl 2-(methylamino)benzoate; 2-methyl-1-phenylpropan-2-yl acetate; 2,6-dimethylheptan-2-ol; 3-(3-isopropylphenyl)butanal; (E)-undec-9-enenitrile; 1-phenylethyl acetate; (E)-3,7-dimethylocta-2,6-dien-1-ol; (E)-3,7-dimethylocta-2,6-dien-1-yl acetate; methyl 3-oxo-2-pentylcyclopentaneacetate; (Z)-hex-3-en-1-yl 2-hydroxybenzoate; (E)-4-(2,6,6-trimethylcyclohex-1-en-1-yl)but-3-en-2-one; (E)-3-methyl-4-(2,6,6-trimethylcyclohex-2-en-1-yl)but-3-en-2-one; (E)-4-(2,6,6-trimethylcyclohex-2-en-1-yl)but-3-en-2-one; (E)-2-methoxy-4-(prop-1-en-1-yl)phenol; 2-hexylcyclopent-2-en-1-one; (E)-3-methyl-4-(2,6,6-trimethylcyclohex-2-en-1-yl)but-3-en-2-one; 3-butyl-5-methyltetrahydro-2H-pyran-4-yl acetate; 3,7-dimethylocta-1,6-dien-3-ol; 2-(5-methyl-5-vinyltetrahydrofuran-2-yl)propan-2-ol; 3,7-dimethylocta-1,6-dien-3-yl acetate; (4-isopropylcyclohexyl)methanol; 3-methyl-5-phenylpentan-1-ol; methyl 2-aminobenzoate; methyl benzoate; methyl 2-hydroxybenzoate; (2Z)-3,7-dimethylocta-2,6-dien-1-ol; (Z)-3,7,11-trimethyldodeca-1,6,10-trien-3-ol; 2-ethoxynaphthalene; 1-(3-methylbenzofuran-2-yl)ethanone; (Z)-3,7-dimethylocta-2,6-dien-1-yl acetate; 3-(4-(2-methylpropyl)-2-methylphenyl)propanal; 1-(2-naphtalenyl)-ethanone; 3,7-dimethyloctan-1-ol; 2-phenylethyl acetate; (2E,5E)-5,6,7-trimethylocta-2,5-dien-4-one; dec-9-en-1-ol; 4-methyl-2-(2-methylprop-1-en-1-yl)tetrahydro-2H-pyran; 4-methyl-2-phenyl-3,6-dihydro-2H-pyran; 2-methyl-3-[4-(2-methylpropyl)phenyl]propanal; 1-phenylethyl acetate; 3,7-dimethyloctan-3-ol; (E)-tridec-2-enenitrile; 3-phenylbutanal; 3-(benzo[d][1,3]dioxol-5-yl)-2-methylpropanal; and 2-methoxynaphtalene. Those ingredients are particularly suitable for providing a perfume with a floral character.

In a preferred embodiment of the present invention, the perfume composition comprises, preferably consists of, at least one, preferably at least two, more preferably at least four, even more preferably at least six, biodegradable ingredient(s) selected from the group consisting of 2,6,10-trimethylundec-9-enal; decanal; undec-10-enal; undecanal; dodecanal; 2-methylundecanal; octanal; (E)-undec-9-enal; (E)-3,7-dimethylocta-2,6-dienal; (E)-dec-4-enal; (E)-dodec-2-enal; 3-(3-isopropylphenyl)butanal; (E)-undec-9-enenitrile; (E)-hex-2-enal; (2E,6Z)-3,7-dimethylnona-2,6-dienenitrile; 2,6-dimethylhept-5-enal; (Z)-non-6-enal; orange terpenes; 2,4,7-Trimethyl-6-octen-1-ol; 1-methyl-4-propan-2-ylcyclohexa-1,4-diene; 1-methyl-4-(propan-2-ylidene)cyclohex-1-ene; (E)-tridec-2-enenitrile; and 3-(benzo[d][1,3]dioxol-5-yl)-2-methylpropanal. Those ingredients are particularly suitable for providing a perfume with a citrus-aldehydic character.

In a preferred embodiment of the present invention, the perfume composition comprises, preferably consists of, at least one, preferably at least two, more preferably at least four, even more preferably at least six, biodegradable ingredient(s) selected from the group consisting of prop-2-enyl 2-(3-methylbutoxy)acetate; (1s,4s)-1,3,3-trimethyl-2-oxabicyclo[2.2.2]octane; 1-(5,5-dimethylcyclohex-1-en-1-yl)pent-4-en-1-one; (Z)-hex-3-en-1-ol; (Z)-hex-3-en-1-yl acetate; methyl non-2-ynoate; (E)-methyl non-2-enoate; (2E,6Z)-nona-2,6-dienal; (Z)-non-6-enal; (Z)-non-6-en-1-ol; 2,6,6-trimethylbicyclo[3.1.1]hept-2-ene; 6,6-dimethyl-2-methylenebicyclo[3.1.1]heptane; 1-phenylethyl acetate; 1-methyl-4-propan-2-ylcyclohexa-1,4-diene; 2-(4-methylcyclohex-3-en-1-yl)propan-2-ol; 1-methyl-4-(propan-2-ylidene)cyclohex-1-ene; 1-(cyclopropylmethyl)-4-methoxybenzene; (E)-tridec-2-enenitrile; and (E)-4-methyldec-3-en-5-ol. Those ingredients are particularly suitable for providing a perfume with a green-aromatic character.

Furthermore, each of the biodegradable ingredient(s) mentioned herein above can be present at a concentration equal to or higher than the minimum concentration of 0.01 wt.-%, preferably 0.02 wt.-%, more preferably 0.05 wt.-%, even more preferably 0.1 wt.-%, even still more preferably 0.5 wt.-%.

In preferred embodiments of the present invention, the weight ratio of the core relative to the total weight of the capsule, namely the sum of the weight of the core and the weight of the shell, is at least 60 wt.-%, preferably at least 70 wt.-%, more preferably at least 80 wt.-%, even more preferably at least 90 wt.-%. With a high weight ratio of the core relative to the total weight of the capsule, the sustainability of the capsule can be further increased, independent of the shell material used.

In context of the present invention, the shell of the microcapsules can be made of a biodegradable material or a non-biodegradable material.

The shell can comprise a melamine-formaldehyde polymer. This type of core-shell capsule has proved to be particularly suitable for fragrance encapsulation and is described in the prior art, for instance in WO 2008/098387 A1, WO 2016/207180 A1 and WO 2017/001672 A1.

The shell can comprise a polyurea or polyurethane polymer. Also this type of core-shell capsule has been successfully used for perfume encapsulation and has the advantage to address consumer concerns with regard to residual formaldehyde in the composition. Such capsules are also described in the prior art, for instance in WO 2019/174978 A1.

The shell can comprise a polymeric stabilizer that is formed by combination of a polymeric surfactant with at least one aminosilane.

The shell can then additionally comprise a polysaccharide, preferably a polysaccharide comprising beta (1→4) linked monosaccharide units, even more preferably a cellulose derivative, in particular selected form the group consisting of hydroxyethyl cellulose, hydroxypropylmethyl cellulose, cellulose acetate and carboxymethyl cellulose, preferably hydroxyethyl cellulose.

The term “polymeric surfactant” refers to a polymer or a mixture comprising at least one polymer that has the property of lowering the interfacial tension between an oil phase and an aqueous phase, when dissolved in one or both of the phases. This ability to lower interfacial tension is called “interfacial activity”.

The term “formed by combination” in the present context means that the polymeric surfactant and the at least one aminosilane are brought in contact with each other to generate the polymeric stabilizer. Without being bound to any theory, this formation can be the result of an interaction between the polymeric surfactant and the at least one aminosilane, such as through dispersion forces, electrostatic forces or hydrogen bonds. But also a chemical reaction, in strict sense, to form covalent bonds is encompassed by this term.

In other words, the polymeric stabilizer can be regarded as an assembly, which comprises moieties derived from a polymeric surfactant and moieties derived from at least one aminosilane.

The polymeric surfactant is soluble or dispersible in an aqueous phase or in water, respectively. This means that the individual polymeric surfactant macromolecules are substantially separated from each other in these liquids. The resulting system appears transparent or hazy when inspected by the human eye.

The polymeric stabilizer can be a relevant factor to the balance between microcapsule stability with respect to both perfume leakage during storage and perfume release under in-use conditions. In particular, the importance of providing additional stabilization of the oil-water interface has been recognized. The polymeric stabilizer thus provides a stable platform, which allows for the addition of additional shell materials and/or shell precursors to form novel encapsulated perfume compositions. More specifically, the addition of a polysaccharide, preferably a polysaccharide comprising beta (1→4) linked monosaccharide units, even more preferably a cellulose derivative, leads to highly sustainable microcapsules with an excellent release profile.

The polysaccharide may be deposited on the outer surface of the capsule shell formed by the polymeric stabilizer. This results in a multilayer shell having at least one layer of polymeric stabilizer and one layer of polysaccharide. It may improve the imperviousness of the encapsulating shell by increasing the amount of encapsulating material.

To avoid any ambiguity, this aspect of the present invention is by no means restricted to a shell having sharply defined discrete layers, although this is one possible embodiment. More specifically, the layers can also be gradual and undiscrete. On the other hand, and at the other extreme, the shell can even be essentially homogenous.

The polysaccharide may react with unreacted groups of the polymeric stabilizer and increase the density of the cross-linked shell. But the polysaccharide may also interact with the polymeric stabilizer by physical forces, physical interactions, such as hydrogen bonding, ionic interactions, hydrophobic interactions or electron transfer interactions.

The shell additionally comprising a polysaccharide can be further stabilized with a stabilizing agent. Preferably the stabilizing agent comprises at least two carboxylic acid groups. Even more preferably, the stabilizing agent is selected from the group consisting of citric acid, benzene-1,3,5-tricarboxylic acid, 2,5-furandicarboxylic acid, itaconic acid, poly(itaconic acid) and combinations thereof.

In a particular embodiment of the present invention, the polymeric surfactant comprises, in particular consists of, a polysaccharide comprising carboxylic acid groups. It has been found that combining such a polymeric surfactant with at least one aminosilane results in the formation of a polymeric stabilizer, which is more sustainable than stabilizers known in the prior art, particular in terms of environment and resources protection.

Without being bound by any theory, it is surmised that the carboxylic acid groups may interact with the at least one aminosilane in a manner mentioned hereinabove.

The polysaccharide comprising carboxylic acid groups may comprise uronic acid units, in particular hexuronic acid units. Polysaccharides having uronic acid units, in particular hexuronic acid units, are broadly available in nature.

The hexuronic acid units can be selected from the group consisting of galacturonic acid units, glucuronic acid units, in particular 4-O-methyl-glucuronic acid units, guluronic acid units and mannuronic acid units.

The polysaccharide comprising carboxylic acid groups may be branched. Branched polysaccharides comprising carboxylic acid groups have the advantage of forming more compact networks than linear polysaccharides and therefore may favor the imperviousness of the encapsulating shell, resulting in reduced leakage and greater encapsulation efficiency.

The polymeric surfactant can be selected from pectin, gum Arabic and an alginate. As illustrated in the examples, these polysaccharides offer a most suitable combination of solubility, viscosity and interfacial activity that make the microcapsules according to the invention particularly performing in terms of handling, storage stability and olfactive performance. The polymeric surfactant may also be hyaluronic acid.

The aminosilane employed in the formation of the polymeric stabilizer can be selected from a compound of Formula (I).

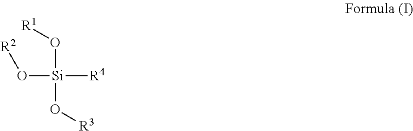

In the above Formula (I), R¹, R² and R³ are each independently C₁-C₄ linear or branched alkyl or alkenyl residues, in particular methyl or ethyl, and R⁴ is a C₁-C₁₂, preferably a C₁-C₄, linear or branched alkyl or alkenyl residue comprising an amine functional group, in particular a primary, secondary or tertiary amine.

When the functional group is a primary amine, it can be a terminal primary amine. R⁴ is then preferably a C₁-C₈, even more preferably a C₁-C₄, linear terminal primary aminoalkyl residue. Specific aminosilanes of this category are selected from the group consisting of aminomethyltriethoxysilane, 2-aminoethyltriethoxysilane, 3-aminopropyltriethoxysilane, 4-aminobutyltri-ethoxysilane, 5-aminopentyltriethoxysilane, 6-aminohexyltriethoxysilane, 7-aminohptyltriethoxysilane and 8-aminooctyltriethoxysilane.

Without being bound by any theory, it is surmised that the silane groups polycondensate with one another to form a silica network at a liquid-liquid interface that additionally stabilizes this interface.

The aminosilane can be a bipodal aminosilane. By “bipodal aminosilane” is meant a molecule comprising at least one amino group and two residues, each of these residues bearing at least one alkoxysilane moiety.

In particular embodiments of the present invention, the at least one bipodal aminosilane has the Formula (II).

(O—R⁴)_{(3-f)}(R³)_{f}Si—R²—X—R²—Si(O—R⁴)_{(3-f)}(R³)_{f} Formula (II)

In the above Formula (II), X stands for —NR¹—, —NR¹—CH₂—NR¹—, —NR¹—CH₂—CH₂—NR¹—, —NR¹—CO—NR¹—, or

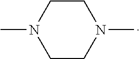

In the above Formula (II), R¹ each independently stand for H, CH₃ or C₂H₅. R² each independently stand for a linear or branched alkylene group with 1 to 6 carbon atoms. R³ each independently stand for a linear or branched alkyl group with 1 to 4 carbon atoms. R⁴ each independently stand for H or for a linear or branched alkyl group with 1 to 4 carbon atoms. f stands for 0, 1 or 2.

Bipodal aminosilanes are particularly advantageous for forming stable oil-water interfaces, compared to conventional silanes.

Examples of bipodal aminosilanes include, but are not limited to, bis(3-(triethoxysilyl)propyl)amine, N,N′-bis(3-(trimethoxysilyl)propyl)urea, bis(3-(methyldiethoxysilyl) propyl)amine, N,N′-bis(3-(trimethoxysilyl)propyl) ethane-1,2-diamine, bis(3-(methyldimethoxysilyl)propyl)-N-methylamine and N,N′-bis(3-(triethoxysilyl) propyl)piperazine.

The bipodal aminosilane can be a secondary aminosilane. Using a secondary bipodal aminosilane instead of primary aminosilane decreases the reactivity of the polymeric stabilizer with respect to electrophilic species, in particular aldehydes. Hence, benefit agents containing high levels of aldehydes may be encapsulated with a lower propensity for adverse interactions between core-forming and shell-forming materials.

The secondary bipodal aminosilane can be bis(3-(triethoxysilyl)propyl)amine. This particular secondary aminosilane has the advantage of releasing ethanol instead of more toxic and less desirable methanol during the polycondensation of the ethoxysilane groups.

Other aminosilanes may also be used in combination with the aforementioned bipodal aminosilanes, in particular the aminosilanes described hereinabove.

The aminosilane to polymeric surfactant weight ratio can be from 0.1 to 1.1, in particular from 0.2 to 0.9, even more particularly from 0.3 to 0.7, for example 0.5.

The polymeric stabilizer can be formed by combination of a polymeric surfactant with at least one aminosilane and further a polyfunctional isocyanate. Polyfunctional isocyanates may densify the arrangement of the polymeric surfactant at the oil/water interface. Without being bound by any theory, it is supposed that the polyfunctional isocyanate cross-links both aminosilanes and polysaccharides by forming polyurea and polyurethane bonds.

The polyfunctional isocyanate may be selected from alkyl, alicyclic, aromatic and alkylaromatic, as well as anionically modified polyfunctional isocyanates, with two or more (e.g. 3, 4, 5, etc.) isocyanate groups in a molecule.

Preferably, at least one polyfunctional isocyanate is an aromatic or an alkylaromatic polyfunctional isocyanate, the alkylaromatic polyfunctional isocyanate having preferably methylisocyanate groups attached to an aromatic ring. Both aromatic and methylisocyanate-substituted alkylaromatic polyfunctional isocyanates have a superior reactivity compared to alkyl and alicyclic polyfunctional isocyanates. Among these, 2-ethylpropane-1,2,3-triyl tris((3-(isocyanatomethyl)phenyl)carbamate) is particularly preferred, because of its tripodal nature that favors the formation of intermolecular cross-links and because of its intermediate reactivity that favors network homogeneity. This alkylaromatic polyfunctional isocyanate is commercially available under the trademark Takenate D-100 N, sold by Mitsui or under the trademark Desmodur® Quix175, sold by Covestro.

In a particularly preferred embodiment of the present invention, the polymeric stabilizer is formed by combination of pectin with bis(3-(triethoxysilyl)propyl)amine. Preferably, the polymeric stabilizer is formed by combination of pectin with bis(3-(triethoxysilyl)propyl)amine and 2-ethylpropane-1,2,3-triyl tris((3-(isocyanatomethyl)phenyl)carbamate). These combinations of natural polymeric surfactant and bipodal secondary aminosilane provide particularly advantageous interface stability and release properties. The stabilized interface is sufficiently impervious to effectively encapsulate the at least one benefit agent comprised in the core. The polymeric stabilizer effectively forms a shell encapsulating the at least one perfume ingredient comprised in the core.

As a further alternative, the shell can comprise a complex coacervate formed of at least one protein and at least one polysaccharide. Such core-shell capsules have proved suitable for fragrance encapsulation and are described in the prior art, for instance in WO 1996/020612 A1, WO 2001/03825 A1 or WO 2015/150370 A1.

In a preferred embodiment of the present invention, the shell is formed by cross-linking of the at least one protein with a first cross-linking agent, in order to form a simple coacervate, followed by the addition of the at least one polysaccharide to form a complex coacervate.

By “coacervate” it is meant polyelectrolyte-rich droplets coexisting with an aqueous, polyelectrolyte poor continuous phase. The droplet agglomerate at interfaces to form an interfacial layer.

In the present context, the coacervate droplets agglomerate at the interface between the core composition and the aqueous phase. As a result, a stable core composition emulsion in water is formed, comprising a plurality of core composition droplets, each droplet being surrounded by coacervate droplets. These stabilize the emulsion in that it prevents the droplets from coalesce.

These stabilized droplets act as templates on which the microencapsulation takes place.

By “simple coacervation” is meant in the present context the formation of an interfacial layer comprising a single polyelectrolyte.

By “complex coacervation” is meant the formation of an interfacial layer comprising a mixture of polyelectrolytes.

The phenomenon of simple or complex coacervation may be observed under a light microscope, wherein it is marked by the appearance of a ring around the core composition droplet. This ring consists of the aforementioned polyelectrolyte-rich phase that has a different refractive index than the surrounding aqueous phase.

The coacervation of a single polyelectrolyte is generally induced by bringing the polyelectrolyte to its isoelectric point, meaning the point where the net charge of the polyelectrolyte is zero or close to zero. This may be achieved by changing the salt concentration or, in the case of a polyampholyte, such as proteins, by changing the pH of the medium.

It has been found that simple coacervation may also be induced by cross-linking a protein at the core composition/water interface.

More specifically, it has been found that building first a simple cross-linked protein coacervate at the core composition/aqueous phase interface, followed by the complex coacervation of this cross-linked protein with a second polyelectrolyte, namely at least one polysaccharide, leads to the formation of a shell having enhanced imperviousness. In particular, the shell shows enhanced imperviousness with respect to low-molecular weight materials, i.e. materials having a molecular weight lower than 250 g/mol, such as fragrance ingredients.

Furthermore, compared to conventional coacervate microcapsules, capsules obtained by such a process show increased stability in liquid consumer product formulations, in particular water-based consumer products, such as fabric care conditioners.

Moreover, the applicant has found that by performing the aforementioned process, it is possible to better control the size of the microcapsules, compared to conventional complex coacervation. In particular, it becomes possible to obtain microcapsules in sizes below 75 μm. This is much lower than the microcapsule sizes reported in the prior art. This is also much more advantageous as it is known that microcapsules having size below 75 μm deposit better on substrates during rinse-off applications than larger microcapsules.

Proteins that are particularly suitable for this aspect of the present invention include gelatins, whey proteins, pea proteins, soy proteins, caseins and albumins, for instance bovine serum albumin.

In preferred embodiments the at least one protein is a gelatin, preferably a Type B gelatin. Type B gelatin can be obtained from the alkaline treatment of collagen and is well known for its ability to form complexes with anionic polyelectrolytes, such as negatively charged polysaccharides under mild acidic conditions.

Gelatin is usually characterized by so-called “Bloom Strength”. In the present context, the Bloom Strength refers to the rigidity of a gelatin film, as measured by so-called “Bloom Gelometer”, according to the Official Procedures of the Gelatin Manufacturers Institute of America, Inc., revised 2019, Chapter 2.1. According to this procedure, the Bloom Strength, expressed in Bloom, is equal to the weight, expressed in g, required to move vertically a standardized plunger, having a diameter of 12.5 mm, to a depth of 4 mm into a gelatin gel, which has been prepared under controlled conditions, i.e. by dissolving 6.67 wt.-% of gelatin in deionized water at 60° C., in a standardized jar, and letting the gel form for 17 hours at 10° C. The higher the weight is, the higher is the Bloom Strength of the gelatin used for making the tested gel.

In preferred embodiments the Type B gelatin has a Bloom Strength of 200 to 250 Bloom. If the Bloom Strength is too low, the gel is mechanically weak and coacervates obtained therefrom may not form a self-standing layer of gelatin-rich phase around the core composition. If the Bloom Strength is too high, then the coacervates and the gelatin-rich phase obtained therefrom may be too brittle.

The Type B gelatin can be obtainable from fish, because fish gelatin meets better acceptance within consumer than beef or pork gelatin, mainly due to health concerns, sociological context or religious rules.

Alternatively, the protein may be a vegetable protein, in particular a pea protein and/or a soy protein, which have the advantage of being vegan.

In preferred embodiments, the first cross-linking agent is a trifunctional alkylaromatic isocyanate. As mentioned before, and without being bound by any theory, the applicant believes that alkylaromatic isocyanate groups have the advantage of possessing an intermediate reactivity compared to the highly reactive aromatic isocyanates and the less reactive aliphatic isocyanate.

More preferably, the trifunctional alkylaromatic isocyanate is an adduct of 2-ethylpropane-1,2,3-triol or 2-ethyl-2-(hydroxymethyl)propane-1,3-diol with 1-isocyanato-2-(isocyanatomethyl)benzene, 1-isocyanato-3-(isocyanatomethyl)benzene and/or 1-isocyanato-4-(isocyanatomethyl)-benzene.

In a particularly preferred embodiment, the trifunctional araliphatic isocyanate is an adduct of 2-ethylpropane-1,2,3-triol with 1-isocyanato-3-(isocyanatomethyl)benzene. Adducts of 2-ethylpropane-1,2,3-triol with 1-isocyanato-3-(isocyanatomethyl)benzene are available commercially under the trade names Takenate D110-N (ex Mitsui Chemicals) or Quix 175 (ex Covestro).

In connection with this aspect of the present invention, the at least one polysaccharide preferably comprises carboxylic acid groups. Polysaccharides comprising carboxylic acid groups are particularly suitable for complex coacervation with proteins, in particular with Type B gelatin. This is due to the fact that the net electrical charge of these polysaccharides may be adjusted by adjusting the pH, so that the complexation with ampholytic proteins is facilitated. Complexation occurs at the pH where the protein has an overall positive electrical charge, whereas the polysaccharide as an overall negative charge, so that the overall electrical charge of the complex is neutral. These polysaccharides include native polysaccharides from nature and modified polysaccharides. Monovalent alkaline metal salts of these polysaccharides may also be used.

In particular, the at least one polysaccharide is selected from the group consisting of carboxymethylcellulose, gum Arabic, alginate, pectin, hyaluronic acid, xanthan gum, gellan gum, and their salts with monovalent alkaline metals. Carboxymethylcellulose, sodium carboxymethylcellulose and gum Arabic are particularly preferred.

In preferred embodiments, the imperviousness and stability of the shell may be further improved by cross-linking of the complex coacervate with a second cross-linking agent. In particularly preferred embodiments, the second cross-linking agent is a difunctional aldehyde selected from the group consisting of succinaldehyde, glutaraldehyde, glyoxal, benzene-1,2-dialdehyde, benzene-1,3-dialdehyde, benzene-1,4-dialdehyde, piperazine-N,N-dialdehyde, and 2,2′-bipyridyl-5,5′-dialdehyde. Di-functional aldehydes are known to be effective cross-linking agents for proteins.

With regard to this aspect of the present invention, the weight ratio of the first cross-linking agent, in particular the trifunctional araliphatic isocyanate, to the at least one protein, in particular the gelatin, can be from 0.08 to 1.2, preferably from 0.12 to 0.8, more preferably from 0.16 to 0.6, even more preferably from 0.2 to 0.4. With such weight ratios of first cross-linking agent to protein, good stability of the microcapsules, in particular with respect to leakage, can be achieved while at the same time ensuring biodegradability.

The weight ratio of polysaccharide to protein typically depends on the nature of the polysaccharide. Without being bound by any theory, it is assumed that this weight ratio depends on the degree of substitution of the polysaccharide, in particular with carboxylic or carboxylate groups, if applicable. Preferably, the weight ratio between the at least one polysaccharide and the at least one protein is from 0.05 to 0.5, preferably from 0.08 to 0.2.

The shell can comprise, in polymerized form, one or more monoethylenically unsaturated and/or polyethylenically unsaturated monomer(s). Also this type of core-shell capsule has been successfully used for perfume encapsulation. Such capsules are described in the prior art, for instance in WO 2013/111912 A1 or WO 2014/032920 A1.

In preferred embodiments of the present invention, the volume median diameter Dv(50) of the plurality of core-shell microcapsules is from 1 to 100 μm, preferably 5 to 75 μm, more preferably 8 to 60 μm, even more preferably 10 to 30 μm. Microcapsules having volume median diameter in the range from 10 to 30 μm show optimal deposition on various substrates, such as fabrics and hair.

Microcapsules according to the present invention may be further processed. Further processing may include treatment of the composition with anti-microbial preservatives. Further processing may also include the addition of a suspending aid, such as a hydrocolloid suspending aid to assist in the stable physical dispersion of the microcapsules and prevent any creaming or coalescence. Any additional adjuvants conventional in the art may also be added during further-processing.

According to the present invention, if desired, core-shell microcapsules may be coated with a functional coating. A functional coating may entirely or only partially coat the microcapsule shell. Whether the functional coating is charged or uncharged, its primary purpose is to alter the surface properties of the microcapsule to achieve a desirable effect, such as to enhance the deposition of the microcapsule on a treated surface, such as a fabric, human skin or hair. Functional coatings may be post-coated to already formed microcapsules, or they may be physically incorporated into the microcapsule shell during shell formation. They may be attached to the shell by physical forces, physical interactions, such as hydrogen bonding, ionic interactions, hydrophobic interactions, electron transfer interactions, or they may be covalently bonded to the shell.

The resultant encapsulated composition, presented in the form of a slurry of microcapsules suspended in an aqueous suspending medium, may be incorporated as such in a consumer product base. If desired, however, the slurry may be dried to present the encapsulated composition in dry powder form. Drying of a slurry of microcapsules is conventional, and may be carried out according techniques known in the art, such as spray-drying, evaporation, lyophilization or use of a desiccant. Typically, as is conventional in the art, dried microcapsules will be dispersed or suspended in a suitable powder, such as powdered silica, which can act as a bulking agent or flow aid. Such suitable powder may be added to the encapsulated composition before, during or after the drying step.

The present invention also relates to a consumer product comprising an encapsulated composition as described herein above, preferably a fabric care product, a home care product or a personal care product.

Biodegradation is of particular importance for the aforementioned categories of consumer products, as during and after their intended use, components of these products enter the environment via domestic waste water. Biodegradation is the main process of removal in waste water treatment plants, environmental waters and soils.

The encapsulated compositions of the present invention that comprise fragrance ingredients may be used to perfume all manners of consumer products, including laundry care detergents, laundry care conditioners, fabric refreshers, personal care cleansing compositions, such as shampoos, bath and shower gels, liquid soaps, soap bars, personal care conditioning composition, such as hair care conditioners, bath and shower lotions, deodorant compositions, antiperspirant compositions, home care compositions, such as hard surface cleaners, and heavy duty detergents. Encapsulated compositions according to the present invention are particularly useful when employed as perfume delivery vehicles in consumer goods that require, for delivering optimal perfumery benefits, the microcapsules to adhere well to a substrate on which they are applied. Such consumer goods include hair shampoos and conditioners, as well as textile-treatment products, such as laundry detergents and conditioners.

A consumer product can contain the compositions as described herein above, preferably at a level of 0.005 to 5 wt.-%, more preferably from 0.01 to 1 wt.-% and still more preferably from 0.02 to 0.5 wt.-% of the consumer product.

Consumer products as described herein above can additionally comprise a non-encapsulated perfume composition. The non-encapsulated perfume composition can comprise, preferably consists of, at least one, preferably at least two, more preferably at least four, even more preferably at least eight, even still more preferably at least 16, even still further more preferably at least 32, even yet still further more preferably at least 64, biodegradable ingredient(s). The biodegradable ingredient(s) can be present at a total concentration of at least 75 wt.-%, preferably at least 80 wt.-%, more preferably at least 85 wt.-%, even more preferably at least 90 wt.-%, even still more preferably at least 95 wt.-%, relative to the total weight of the perfume composition. The biodegradable ingredient(s) can be selected from the groups specified herein above. The non-encapsulated perfume composition can be identical or different from the perfume composition used in the encapsulated composition as described herein above.

A further aspect of the present invention relates to a use of the encapsulated composition as described herein above for obtaining a consumer product.

The present disclosure also relates to a use of an encapsulated composition as described herein above to enhance the performance of a benefit agent in a consumer product, or to a method for enhancing the performance of a benefit agent in a consumer product by adding an encapsulated composition according to the present invention, respectively.

The following is a preferred way for conducting OECD Method 301F.

Principle:

A measured volume of inoculated mineral medium, containing a known concentration of test substance as the nominal sole source of organic carbon, is stirred in a closed flask at a constant temperature. Evolved carbon dioxide is absorbed in sodium hydroxide pellets. The consumption of oxygen is determined by measuring the pressure drop in the respirometer flask. The Biological Oxygen Demand (BOD), amount of oxygen taken up by the microbial population during biodegradation of the test chemical (corrected for uptake by blank inoculum, run in parallel) is expressed as a percentage of ThOD (Theoretical Oxygen Demand, calculated from the elemental composition, assuming that carbon is oxidized to carbon dioxide, hydrogen to water and nitrogen to ammonium, nitrite or nitrate).

Apparatus:

The respirometer used is an Oxitop Control System, made by Wissenschaftlich-Technische Werkstatten (WTW), Weilheim, Germany.

Water:

The water used is ultrapure water, containing less than 5 ppb total organic carbon, produced by using a Millipore Direct-Q 3 UV purification system.

Stock Solutions of Mineral Components:

Solution A:

| | |
|---|---|
| KH₂PO₄ | 8.5 g |
| K₂HPO₄ | 21.75 g |
| Na₂HPO₄•2 H₂O | 33.4 g |
| NH₄Cl | 0.5 g |

dissolved in water and made up to 1 liter.

Solution B:

| | |
|---|---|
| CaCl₂ | 27.5 g |

dissolved in water and made up to 1 liter.

Solution C:

| | |
|---|---|
| MgSO₄•7 H₂O | 22.5 g |

dissolved in water and made up to 1 liter.

Solution D:

| | |
|---|---|
| FeCl₃•6 H₂O | 0.25 g |
| HCl Conc. | one drop |

dissolved in water and made up to 1 liter.

Mineral Medium:

The mineral medium is prepared by mixing 50 ml of solution A and 2 liters deionized water, adding 5 ml of each of the solutions B, C and D and making up to 5 liters with deionized water. The pH is measured and if necessary adjusted to 7.4±0.2 with phosphoric acid or potassium hydroxide.

Inoculum:

Fresh activated sludge from a biological waste water treatment plant treating predominantly domestic sewage (Bois-de-Bay, Satigny, Switzerland) is used.

The sludge is collected in the morning, washed three times in the mineral medium (by centrifuging at 1000 g for 10 minutes, discarding the supernatant and resuspending in mineral medium) and kept aerobic until being used on the same day.

Determination of the Dry Weight of Suspended Solids:

The dry weight of suspended solids is determined by taking two 50 ml samples of the homogenized sludge, evaporating water on a steam bath, drying in an oven at 105 to 110° C. for two hours and weighing the residue.

Reference Substance:

Sodium benzoate (Fluka, Buchs, Switzerland, Art. No. 71300), purity: min. 99.0%.

Preparation of the Flasks:

Test substance samples (corresponding to 30.0 mg/I in 255 ml of test medium) are weighed in small aluminium boats and added directly to the test flasks of the Oxitop. For reference substance samples 12.75 mg (corresponding to 50.0 mg/I in 255 ml of test medium) are weighed in small aluminium boats and added directly to the test flasks of the Oxitop.

Flasks are filled with 250 ml of mineral medium. Samples of test or reference substance are added. Then 5.00 ml of suspended sludge diluted to a concentration of 1.53 g/I dry matter is added. Except when the test substance had an acid or alkaline character, the pH of each flask is not measured but assumed to be the same as the mineral medium, in order not to remove any floating undissolved test substance from the test medium by dipping a glass electrode in it. Neutral test substances, even sodium benzoate, were shown not to affect the pH of the medium by more than 0.1 pH unit. Two sodium hydroxide pellets are placed in the quivers on top of the bottle, and the flasks are closed tightly with the measuring heads. The flasks are allowed to equilibrate to the test temperature. The measurement is started by programming the measuring unit of the Oxitop test flasks, and the test flasks are placed in the temperature controlled cupboard of the Oxitop system. After temperature equilibration, the controller of the instrument started data acquisition (time zero of the experiment).

Test Temperature:

The test temperature is 21.5±0.5° C.

Performance of the Test:

Every day the oxygen consumption of each flask is recorded, and correct temperature and stirring are checked. At the end of the test period (normally 28 days), the pH of each flask is measured again.

The biodegradation for each data point is calculated as follows:

D=(C−B)/ThOD·100%

D: Biodegradation of sample

C: O₂ uptake of sample and sludge

B: O₂ uptake of sludge (inoculum blank)

ThOD: Theoretical oxygen demand

The pass level for “ready biodegradability” is to reach 60% of theoretical oxygen demand (ThOD). This pass value has to be reached in a 10-day window within the 28-day period of the test. The 10-day window begins when the degree of biodegradation has reached 10% of theoretical oxygen demand (ThOD) and must end before day 28 of the test.

The pass level for “inherently biodegradable” is also 60% of theoretical oxygen demand (ThOD). However, this pass value can be reached after the 28-day period of the test, which is usually extended to 60 days. No 10-day window applies.

Further features and particular advantages of the present invention become apparent from the following examples.

### EXAMPLE 1: PERFUME COMPOSITIONS CONSISTING OF BIODEGRADABLE INGREDIENTS

Perfume compositions consisting of biodegradable ingredients can be prepared by mixing such ingredients according to the formulae provided in Table 1.

TABLE 1

| | Perfume No. | | | | | | |
|---|---|---|---|---|---|---|---|
| | 1 | 2 | 3 | 4 | 5 | 6 | 7 |
| Ingredient | Amount (wt.-%) | | | | | | |
| (2S,4S)-1,7,7- | | | | | | 20 | |
| trimethylbicyclo[2.2.1]heptan-2-yl | | | | | | | |
| acetate | | | | | | | |
| (E)-3,7-dimethylocta-2,6-dien-1-yl | | | | | 10 | | |
| acetate | | | | | | | |
| hexyl acetate | | 10 | | | | | |
| 4-(tert-butyl)cyclohexyl acetate | | 10 | | | 25 | | |
| 2,6,10-trimethylundec-9-enal | | | | | | | 1 |
| 2-(tert-butyl)cyclohexyl acetate | | 10 | | 25 | 10 | | |
| decanal | | | | | | | 1 |
| undec-10-enal | | | | | | | 1 |
| dodecanal | | | | | 5 | | 5 |
| 2-methylundecanal | | 10 | 5 | | | 10 | |
| (E)-undec-9-enal | | | | | 1 | | |
| prop-2-enyl 2-(3-methylbutoxy)acetate | | | 5 | | | | 5 |
| prop-2-enyl 3-cyclohexylpropanoate | 5 | | | | | | 5 |
| prop-2-enyl heptanoate | | | | 10 | | | 5 |
| (Z)-oxacycloheptadec-10-en-2-one | | | | | | | 1 |
| (3aR,5aS,9aS,9bR)-3a,6,6,9a- | | | | | 1 | | 2 |
| tetramethyl-2,4,5,5a,7,8,9,9b-octahydro- | | | | | | | |
| 1H-benzo[e][1]benzofuran | | | | | | | |
| methyl 2-aminobenzoate | | | | | 1 | | |
| 4-methoxybenzaldehyde | | | | | 1 | | 2 |
| 5-isopropyl-2-methylphenol | | | | | | | 1 |
| 3,7-dimethyloct-6-en-1-ol | | | 5 | | | | |
| 3,7-dimethyloct-6-en-1-yl acetate | | | | | | | 5 |
| (Z)-3-methylcyclotetradec-5-enone | | | | | 1 | | |
| 3-(4-isopropylphenyl)-2-methylpropanal | | | | | 1 | | |
| (E)-1-(2,6,6-trimethylcyclohexa-1,3-dien- | | | 1 | | | | |
| 1-yl)but-2-en-1-one | | | | | | | |
| (E)-l-(2,6,6-trimethylcyclohex-2-en-1- | | | | | | 5 | 1 |
| yl)but-2-en-1-one | | | | | | | |
| 5-hexyloxolan-2-one | | | 10 | | | | |
| 3-methyl-2-pentylcyclopent-2-enone | | 1 | | | | | |
| 2,6-dimethyloct-7-en-2-ol | | | 30 | | 10 | | |
| 2-methyl-1-phenylpropan-2-yl acetate | | | | | | | 10 |
| oxydibenzene | | | | | | 10 | |
| 6-heptyltetrahydro-2H-pyran-2-one | | 1 | 10 | | | | |
| 5-octyloxolan-2-one | | 1 | | 10 | | | |
| (E)-3-methyl-5-(2,2,3- | 5 | | 1 | | | | |
| trimethylcyclopent-3-en-1-yl)pent-4-en- | | | | | | | |
| 2-ol | | | | | | | |
| 2-ethyl-3-hydroxy-4H-pyran-4-one | | 1 | | | 1 | | |
| ethyl 2-methylbutanoate | | | | | | | 10 |
| 3-ethoxy-4-hydroxybenzaldehyde | | 1 | | | | | 5 |
| 1,4-dioxacycloheptadecane-5,17-dione | | | | | | 10 | |
| (1s,4s)-1,3,3-trimethyl-2- | | 10 | | | 1 | 20 | |
| oxabicyclo[2.2.2]octane | | | | | | | |
| Eucalyptus oil | 10 | | | | | | |
| 3a,6,6,9a- | | | 1 | | | | |
| tetramethyldodecahydronaphtho[2,1- | | | | | | | |
| b]furan | | | | | | | |
| 3-(3-isopropylphenyl)butanal | | 1 | | | | | |
| 1-(5,5-dimethylcyclohex-1-en-1-yl)pent- | | | 5 | | | 1 | |
| 4-en-1-one | | | | | | | |
| (E)-3,7-dimethylocta-2,6-dien-1-ol | | | | | | | 5 |
| methyl 3-oxo-2- | 10 | | | | 10 | | 5 |
| pentylcyclopentaneacetate | | | | | | | |
| (E)-4-(2,6,6-trimethylcyclohex-1-en-1- | | | 10 | | | | |
| yl)but-3-en-2-one | | | | | | | |
| (E)-4-(2,6,6-trimethylcyclohex-2-en-1- | | | | | | 10 | |
| yl)but-3-en-2-one | | | | | | | |
| (E)-3-methyl-4-(2,6,6-trimethylcyclohex- | | | 5 | 5 | | | |
| 2-en-1-yl)but-3-en-2-one | | | | | | | |
| 3-butyl-5-methyltetrahydro-2H-pyran-4- | 10 | | 1 | | | | |
| yl acetate | | | | | | | |
| Lavandin oil | 10 | 10 | | | | | |
| (2E,6Z)-3,7-dimethylnona-2,6- | | | 5 | | | | 5 |
| dienenitrile | | | | | | | |
| 3,7-dimethylocta-1,6-dien-3-yl acetate | 10 | | | | | | |
| ethyl 2-methylpentanoate | | | | | | | 5 |
| 2-(2-(4-methylcyclohex-3-en-1- | | | | 10 | 10 | | |
| yl)propyl)cyclopentanone | | | | | | | |
| 1-(3-methylbenzofuran-2-yl)ethanone | | 1 | | | | | |
| 3-(4-(2-methylpropyl)-2- | | | | 10 | | | |
| methylphenyl)propanal | | | | | | | |
| 1-(2-naphtalenyl)-ethanone | | 1 | | | | | |
| Patchouli oil | | 10 | | | | 1 | |
| 5-heptyldihydrofuran-2(3H)-one | | 10 | | | 1 | 1 | 5 |
| 5-pentyldihydrofuran-2(3H)-one | | 1 | | 5 | | | |
| ethyl hexanoate | | | 1 | | | | |
| ethyl 2-methyl butyrate | | | | | | 10 | 10 |
| benzyl 2-hydroxybenzoate | 10 | | | | 5 | | 5 |
| cyclohexyl 2-hydroxybenzoate | | | | 10 | | | |
| 4-(dodecylthio)-4-methylpentan-2-one | | | | | | 1 | |
| 2-methyl-3-[4-(2- | | 1 | | | | | |
| methylpropyl)phenyl]propanal | | | | | | | |
| (E)-2-((3,5-dimethylhex-3-en-2-yl)oxy)- | 10 | 10 | | | 1 | | |
| 2-methylpropyl cyclopropanecarboxylate | | | | | | | |
| 1-methyl-4-(propan-2-ylidene)cyclohex- | 10 | | | | | | |
| 1-ene | | | | | | | |
| 3,7-dimethyloctan-3-ol | | | 5 | 10 | | | |
| (E)-4-methyldec-3-en-5-ol | 10 | | | | 5 | 1 | |
| 2-methoxynaphtalene | | | | 5 | | | |
| Total | 100 | 100 | 100 | 100 | 100 | 100 | 100 |

### EXAMPLE 2: DEGRADATION TESTS OF PERFUME COMPOSITIONS

Perfume compositions according to Table 1 can be submitted to biodegradation testing as described herein above. Since all ingredients used in these perfume compositions are biodegradable ingredients, the perfume compositions will be found to be particularly beneficial in terms of biodegradation.

### EXAMPLE 3: PREPARATION OF MELAMINE-FORMALDEHYDE MICROCAPSULES

Melamine-formaldehyde microcapsules according to the present invention can be prepared by performing the following procedures with a perfume composition as described herein above (Table 1):
Example 1.3 of WO 2008/098387 A1
Example 1 of WO 2016/207180 A1
Example 1 of WO 2017/001672 A1

### EXAMPLE 4: PREPARATION OF POLYUREA MICROCAPSULES

Polyurea microcapsules according to the present invention can be prepared by performing the following procedure with a perfume composition as described herein above (Table 1):
Example 1 of WO 2019/174978 A1

### EXAMPLE 5: PREPARATION OF CELLULOSE MICROCAPSULES

Microcapsules according to the present invention can be prepared by performing the steps of:
a) Preparing a core composition by admixing 0.66 g of bipodal aminosilane (bis(3-triethoxysilylpropyl)amine), 0.48 g of Takenate D-110N (ex Mitsui) and 38.5 g of perfume composition as described herein above (Table 1);
b) Emulsifying the core composition obtained in step a) in a mixture of 1.35 g high methoxylated grade pectin (of type APA 104, ex Roeper) in 66.2 g of water by using a 300 ml reactor and a cross-beam stirrer with pitched beam operating at a stirring speed of 800 rpm at a temperature of 25+/−2° C. for 10 min;
c) Adjusting the pH of the continuous phase of the emulsion to 6.5+/−0.5 with a 10% sodium hydroxide solution in water and maintaining the system at a temperature of 25+/−2° C. for 1 h while maintaining stirring as in step b);
d) Increasing progressively the temperature to 85° C. over 2.5 h and maintaining the temperature at 85° C. for 1 h, while maintaining stirring as in steps b) and c) to complete the formation of core-shell capsules;
e) Adding 1.8 g of 2-hydroxyethyl cellulose and continue stirring for 30 min at 85° C.;
f) Adding 0.8 g of a solution of citric acid diluted at 30% in water and continue stirring for 1 h at 85° C.;
g) Letting the slurry of core-shell capsules obtained in step f) cool to room temperature.

### EXAMPLE 6: PREPARATION OF GELATIN COACERVATE MICROCAPSULES

Gelatin coacervate microcapsules according to the present invention can be prepared by performing the following procedures with a perfume composition as described herein above (Table 1):
Example 1 of WO 1996/020612 A1
Example 2 of WO 2001/03825 A1
One of Examples 1-3 of WO 2015/150370 A1

### EXAMPLE 7: PREPARATION OF GELATIN COACERVATE MICROCAPSULES

Microcapsules according to the present invention can be prepared by performing the steps of:
a) Providing a core composition by dissolving 70 g of a trifunctional araliphatic isocyanate (Takenate N100-D, ex Mitsui Inc., 75 wt.-% active content) in 165 g of a perfume composition as described herein above (Table 1);
b) Providing an aqueous phase by admixing 17 g of Type B gelatin and 150 g of deionized water;
c) Heating up the aqueous phase to 35° C. under stirring, in order to dissolve the gelatin;
d) Emulsifying the core composition in the aqueous phase obtained in step c) at a stirring rate of 1000 rpm, in order to obtain an emulsion of core composition droplets having a volume average diameter Dv(50) of 50 μm, dispersed in water;
e) Heating the emulsion obtained in step d) to a temperature of 90° C. and maintaining the emulsion at this temperature for 10 min;
f) Letting the slurry obtained in step e) cool down to a temperature of 31° C., in order to induce the simple coacervation of the cross-linked gelatin at the core-water-interface, forming thereby a slurry of core-shell microcapsules;
g) Adding 80 g of a 2 wt.-% aqueous solution of carboxymethylcellulose in deionized water and then 534 g of deionized water to the slurry formed in step f), while maintaining the stirring rate at 1000 rpm;
h) Adjusting the pH of the slurry to a value of 5.3 with a 10 wt.-% solution of citric acid in water; while reducing the stirring speed to 600 rpm, in order to form a cross-linked gelatin/polysaccharide coacervate at the surface of the microcapsules obtained in step f);
i) Letting the slurry obtained in step h) cool down to a temperature of 10 to 15° C. over 1 h;
j) Adding 0.26 g of glutaraldehyde while keeping the slurry under stirring at 15° C. for 1 min. Letting the slurry warm up to room temperature within 1 h, in order to obtain a slurry of microcapsules;
k) Completing to 1000 g with deionized water.

### EXAMPLE 8: PREPARATION OF POLYACRYLATE-BASED MICROCAPSULES

Polyacrylate-based microcapsules according to the present invention can be prepared by performing the following procedure with a perfume composition as described herein above (Table 1):
Example 1 of WO 2013/111912 A1
Example 1 of WO 2014/032920 A1

1. An encapsulated composition comprising a plurality of core-shell microcapsules, wherein the core-shell microcapsules comprise a core and a shell surrounding the core, wherein the core comprises a perfume composition comprising at least one biodegradable ingredient(s), wherein the biodegradable ingredient(s) is/are present at a total concentration of at least 75 wt.-% relative to the total weight of the perfume composition.

2. The encapsulated composition according to claim 1,
wherein the biodegradable ingredient(s) is/are selected from the group consisting of:
(E)-2-methoxy-4-(prop-1-en-1-yl)phenyl acetate; 2,6,10-trimethylundec-9-enal; 2-(tert-butyl)cyclohexyl acetate; decanal; undec-10-enal; undecanal; dodecanal; 2-methylundecanal; octanal; 3-(4-isopropylphenyl)-2-methylpropanal; (E)-undec-9-enal; prop-2-enyl 2-(3-methylbutoxy)acetate; prop-2-enyl 3-cyclohexylpropanoate; prop-2-enyl heptanoate; (Z)-oxacycloheptadec-10-en-2-one; (3aR,5aS,9aS,9bR)-3a,6,6,9a-tetramethyl-2,4,5,5a,7,8,9,9b-octahydro-1H-benzo[e][1]benzofuran; pentyl 2-hydroxybenzoate; 4-methoxybenzaldehyde; benzyl acetate; benzyl 2-hydroxybenzoate; (2S,4S)-1,7,7-trimethylbicyclo[2.2.1]heptan-2-yl acetate; 5-isopropyl-2-methylphenol; (1S,8aR)-1,4,4,6-tetramethyl-2,3,3a,4,5,8-hexahydro-1H-5,8a-methanoazulene; (1S,6R,8aR)-1,4,4,6-tetramethyloctahydro-1H-5,8a-methanoazulen-6-yl acetate; (1R,6S,8aS)-6-methoxy-1,4,4,6-tetramethyloctahydro-1H-5,8a-methanoazulene; (E)-3,7-dimethylocta-2,6-dienal; 3,7-dimethyloct-6-en-1-ol; 3,7-dimethyloct-6-en-1-yl acetate; (Z)-3-methylcyclotetradec-5-enone; 1-methoxy-4-methylbenzene; 2-cyclohexylethyl acetate; cyclohexyl 2-hydroxybenzoate; (E)-1-(2,6,6-trimethylcyclohexa-1,3-dien-1-yl)but-2-en-1-one; (E)-1-(2,6,6-trimethylcyclohex-2-en-1-yl)but-2-en-1-one; 5-hexyloxolan-2-one; (E)-dec-4-enal; 2,6-dimethyloct-7-en-2-ol; oxydibenzene; 1-methoxy-4-propylbenzene; 3-methyl-2-pentylcyclopent-2-enone; methyl 2-(methylamino)benzoate; 2-methyl-1-phenylpropan-2-yl acetate; 2-methyl-1-phenylpropan-2-yl butanoate; 2,6-dimethylheptan-2-ol; 6-heptyltetrahydro-2H-pyran-2-one; 5-octyloxolan-2-one; (E)-dodec-2-enal; (E)-3-methyl-5-(2,2,3-trimethylcyclopent-3-en-1-yl)pent-4-en-2-ol; ethyl hexanoate; ethyl 2-methyl butyrate; 2-ethyl-3-hydroxy-4H-pyran-4-one; ethyl heptanoate; 3-ethoxy-4-hydroxybenzaldehyde; 1,4-dioxacycloheptadecane-5,17-dione; (1s,4s)-1,3,3-trimethyl-2-oxabicyclo[2.2.2]octane; 4-allyl-2-methoxyphenol; methyl 2,4-dihydroxy-3,6-dimethylbenzoate; 3a,6,6,9a-tetramethyldodecahydronaphtho[2,1-b]furan; 3-(3-isopropylphenyl)butanal; (E)-undec-9-enenitrile; 1-(5,5-dimethylcyclohex-1-en-1-yl)pent-4-en-1-one; 1-phenylethyl acetate; (E)-3,7-dimethylocta-2,6-dien-1-ol; (E)-3,7-dimethylocta-2,6-dien-1-yl acetate; (E)-oxacyclohexadec-12-en-2-one; methyl 3-oxo-2-pentylcyclopentaneacetate; (E)-hex-2-enal; (Z)-hex-3-en-1-ol; (Z)-hex-3-en-1-yl acetate; (Z)-hex-3-en-1-yl 2-hydroxybenzoate; hexyl acetate; 8,8-di(1H-indol-3-yl)-2,6-dimethyloctan-2-ol; (E)-4-(2,6,6-trimethylcyclohex-1-en-1-yl)but-3-en-2-one; (E)-3-methyl-4-(2,6,6-trimethylcyclohex-2-en-1-yl)but-3-en-2-one; (E)-4-(2,6,6-trimethylcyclohex-2-en-1-yl)but-3-en-2-one; 3-methylbutyl acetate; 3-methylbutyl butanoate; (E)-2-methoxy-4-(prop-1-en-1-yl)phenol; 2-hexylcyclopent-2-en-1-one; (E)-3-methyl-4-(2,6,6-trimethylcyclohex-2-en-1-yl)but-3-en-2-one; 3-butyl-5-methyltetrahydro-2H-pyran-4-yl acetate; 8-isopropyl-1-oxaspiro[4.5]decan-2-one; (2E,6Z)-3,7-dimethylnona-2,6-dienenitrile; 3,7-dimethylocta-1,6-dien-3-ol; 2-(5-methyl-5-vinyltetrahydrofuran-2-yl)propan-2-ol; 3,7-dimethylocta-1,6-dien-3-yl acetate; ethyl 2-methylpentanoate; (4-isopropylcyclohexyl)methanol; 3-methyl-5-phenylpentan-1-ol; 2,6-dimethylhept-5-enal; mercapto-para-menthan-3-one; methyl 2-aminobenzoate; methyl benzoate; 2-ethoxy-4-(methoxymethyl)phenol; 6-methylhept-5-en-2-one; 8-methyl-1-oxaspiro[4.5]decan-2-one; methyl non-2-ynoate; methyl 2-hydroxybenzoate; 2-(2-(4-methylcyclohex-3-en-1-yl)propyl)cyclopentanone; (E)-methyl non-2-enoate; (2Z)-3,7-dimethylocta-2,6-dien-1-ol; (Z)-3,7,11-trimethyldodeca-1,6,10-trien-3-ol; 2-ethoxynaphthalene; 1-(3-methylbenzofuran-2-yl)ethanone; (Z)-3,7-dimethylocta-2,6-dien-1-yl acetate; (2E,6Z)-nona-2,6-dienal; (Z)-non-6-enal; (Z)-non-6-en-1-ol; 3-(4-(2-methylpropyl)-2-methylphenyl)propanal; 6-propyltetrahydro-2H-pyran-2-one; 1-(2-naphtalenyl)-ethanone; 4-(tert-butyl)cyclohexyl acetate; 5-heptyldihydrofuran-2(3H)-one; 3,7-dimethyloctan-1-ol; 2-phenylethyl acetate; 2,6,6-trimethylbicyclo[3.1.1]hept-2-ene; 6,6-dimethyl-2-methylenebicyclo[3.1.1]heptane; (2E,5E)-5,6,7-trimethylocta-2,5-dien-4-one; 2,4,7-Trimethyl-6-octen-1-ol; 3-methylbut-2-en-1-yl acetate; 5-pentyldihydrofuran-2(3H)-one; 4-(4-hydroxyphenyl)butan-2-one; dec-9-en-1-ol; 4-methyl-2-(2-methylprop-1-en-1-yl)tetrahydro-2H-pyran; 4-methyl-2-phenyl-3,6-dihydro-2H-pyran; 2,6,6-trimethylcyclohexa-1,3-dienecarbaldehyde; 4-(dodecylthio)-4-methylpentan-2-one; 2-methyl-3-[4-(2-methylpropyl)phenyl]propanal; 1-phenylethyl acetate; (E)-2-((3,5-dimethylhex-3-en-2-yl)oxy)-2-methylpropyl cyclopropanecarboxylate; 1-methyl-4-propan-2-ylcyclohexa-1,4-diene; 2-(4-methylcyclohex-3-en-1-yl)propan-2-ol; 1-methyl-4-(propan-2-ylidene)cyclohex-1-ene; 3,7-dimethyloctan-3-ol; 1-(cyclopropylmethyl)-4-methoxybenzene; (E)-tridec-2-enenitrile; 3-phenylbutanal; 3-(benzo[d][1,3]dioxol-5-yl)-2-methylpropanal; (E)-4-methyldec-3-en-5-ol; 2-methoxynaphtalene; cedar wood oil; eucalyptus oil; galbanum oil; clove oil; lavandin oil; mandarin oil; orange terpenes; patchouli oil; and ylang oil.

3. The encapsulated composition according to claim 2, wherein each of the biodegradable ingredient(s) is present at a concentration equal to or less than the following maximum concentrations:
(E)-2-methoxy-4-(prop-1-en-1-yl)phenyl acetate: 0.1 wt. %,
2,6,10-trimethylundec-9-enal: 1 wt. %,
2-(tert-butyl)cyclohexyl acetate: 50 wt. %,
decanal: 10 wt. %,
undec-10-enal: 2 wt. %,
undecanal: 5 wt. %,
dodecanal: 10 wt. %,
2-methylundecanal: 50 wt. %,
octanal: 5 wt. %,
3-(4-isopropylphenyl)-2-methylpropanal: 5 wt. %,
(E)-undec-9-enal: 5 wt. %,
prop-2-enyl 2-(3-methylbutoxy)acetate: 5 wt. %,
prop-2-enyl 3-cyclohexylpropanoate: 10 wt. %,
prop-2-enyl heptanoate: 10 wt. %,
(Z)-oxacycloheptadec-10-en-2-one: 2 wt. %,
(3aR,5aS,9aS,9bR)-3a,6,6,9a-tetramethyl-2,4,5,5a,7,8,9,9b-octahydro-1H-benzo[e][1]benzofuran: 2 wt. %,
pentyl 2-hydroxybenzoate: 50 wt. %,
4-methoxybenzaldehyde: 5 wt. %,
benzyl acetate: 10 wt. %,
benzyl 2-hydroxybenzoate: 75 wt. %,
(2S,4S)-1,7,7-trimethylbicyclo[2.2.1]heptan-2-yl acetate: 50 wt. %,
5-isopropyl-2-methylphenol: 1 wt. %,
(1S,8aR)-1,4,4,6-tetramethyl-2,3,3a,4,5,8-hexahydro-1H-5,8a-methanoazulene: 5 wt. %,
(1S,6R,8aR)-1,4,4,6-tetramethyloctahydro-1H-5,8a-methanoazulen-6-yl acetate: 5 wt. %,
(1R,6S,8aS)-6-methoxy-1,4,4,6-tetramethyloctahydro-1H-5,8a-methanoazulene: 5 wt. %,
(E)-3,7-dimethylocta-2,6-dienal: 10 wt. %,
3,7-dimethyloct-6-en-1-ol: 25 wt. %,
3,7-dimethyloct-6-en-1-yl acetate: 25 wt. %,
(Z)-3-methylcyclotetradec-5-enone: 5 wt. %,
1-methoxy-4-methylbenzene: 1 wt. %,
2-cyclohexylethyl acetate: 25 wt. %,
cyclohexyl 2-hydroxybenzoate: 15 wt. %,
(E)-1-(2,6,6-trimethylcyclohexa-1,3-dien-1-yl)but-2-en-1-one: 2.5 wt. %,
(E)-1-(2,6,6-trimethylcyclohex-2-en-1-yl)but-2-en-1-one: 5 wt. %,
5-hexyloxolan-2-one: 15 wt. %,
(E)-dec-4-enal: 1 wt. %,
2,6-dimethyloct-7-en-2-ol: 50 wt. %,
oxydibenzene: 15 wt. %,
1-methoxy-4-propylbenzene: 2 wt. %,
3-methyl-2-pentylcyclopent-2-enone: 5 wt. %,
methyl 2-(methylamino)benzoate: 1 wt. %,
2-methyl-1-phenylpropan-2-yl acetate: 75 wt. %,
2-methyl-1-phenylpropan-2-yl butanoate: 50 wt. %,
2,6-dimethylheptan-2-ol: 5 wt. %,
6-heptyltetrahydro-2H-pyran-2-one: 5 wt. %,
5-octyloxolan-2-one: 10 wt. %,
(E)-dodec-2-enal: 0.5 wt. %,
(E)-3-methyl-5-(2,2,3-trimethylcyclopent-3-en-1-yl)pent-4-en-2-ol: 5 wt. %,
ethyl hexanoate: 10 wt. %,
ethyl 2-methyl butyrate: 15 wt. %,
2-ethyl-3-hydroxy-4H-pyran-4-one: 10 w ethyl heptanoate: 5 wt. %,
3-ethoxy-4-hydroxybenzaldehyde: 10 wt. %,
1,4-dioxacycloheptadecane-5,17-dione: 25 wt. %,
(1s,4s)-1,3,3-trimethyl-2-oxabicyclo[2.2.2]octane: 25 wt. %,
4-allyl-2-methoxyphenol: 5 wt. %,
methyl 2,4-dihydroxy-3,6-dimethylbenzoate: 2 wt. %,
3a,6,6,9a-tetramethyldodecahydronaphtho[2,1-b]furan: 2 wt. %,
3-(3-isopropylphenyl)butanal: 5 wt. %,
(E)-undec-9-enenitrile: 1 wt. %,
1-(5,5-dimethylcyclohex-1-en-1-yl)pent-4-en-1-one: 5 wt. %,
1-phenylethyl acetate: 5% wt. %,
(E)-3,7-dimethylocta-2,6-dien-1-ol: 25 wt. %,
(E)-3,7-dimethylocta-2,6-dien-1-yl acetate: 15 wt. %,
(E)-oxacyclohexadec-12-en-2-one: 15 wt. %,
methyl 3-oxo-2-pentylcyclopentaneacetate: 75 wt. %,
(E)-hex-2-enal: 1 wt. %,
(Z)-hex-3-en-1-ol: 15 wt. %,
(Z)-hex-3-en-1-yl acetate: 15 wt. %,
(Z)-hex-3-en-1-yl 2-hydroxybenzoate: 15 wt. %,
hexyl acetate: 15 wt. %,
8,8-di(1H-indol-3-yl)-2,6-dimethyloctan-2-ol: 2 wt. %,
(E)-4-(2,6,6-trimethylcyclohex-1-en-1-yl)but-3-en-2-one: 25 wt. %,
(E)-3-methyl-4-(2,6,6-trimethylcyclohex-2-en-1-yl)but-3-en-2-one: 5 wt. %,
(E)-4-(2,6,6-trimethylcyclohex-2-en-1-yl)but-3-en-2-one: 25 wt. %,
3-methylbutyl acetate: 5 wt. %,
3-methylbutyl butanoate: 1 wt. %,
(E)-2-methoxy-4-(prop-1-en-1-yl)phenol: 1 wt. %,
2-hexylcyclopent-2-en-1-one: 5 wt. %,
(E)-3-methyl-4-(2,6,6-trimethylcyclohex-2-en-1-yl)but-3-en-2-one: 50 wt. %,
3-butyl-5-methyltetrahydro-2H-pyran-4-yl acetate: 15 wt. %,
8-isopropyl-1-oxaspiro[4.5]decan-2-one: 1 wt. %,
(2E,6Z)-3,7-dimethylnona-2,6-dienenitrile: 25 wt. %,
3,7-dimethylocta-1,6-dien-3-ol: 25 wt. %,
2-(5-methyl-5-vinyltetrahydrofuran-2-yl)propan-2-ol: 1 wt. %,
3,7-dimethylocta-1,6-dien-3-yl acetate: 25 wt. %,
ethyl 2-methylpentanoate: 10 wt. %,
(4-isopropylcyclohexyl)methanol: 5 wt. %,
3-methyl-5-phenylpentan-1-ol: 10 wt. %,
2,6-dimethylhept-5-enal: 2 wt. %,
mercapto-para-menthan-3-one: 1 wt. %,
methyl 2-aminobenzoate: 2 wt. %,
methyl benzoate: 1 wt. %,
2-ethoxy-4-(methoxymethyl)phenol: 1 wt. %,
6-methylhept-5-en-2-one: 5 wt. %,
8-methyl-1-oxaspiro[4.5]decan-2-one: 2 wt. %,
methyl non-2-ynoate: 1 wt. %,
methyl 2-hydroxybenzoate: 1 wt. %,
2-(2-(4-methylcyclohex-3-en-1-yl)propyl)cyclopentanone: 50 wt. %,
(E)-methyl non-2-enoate: 2 wt. %,
(2Z)-3,7-dimethylocta-2,6-dien-1-ol: 10 wt. %,
(Z)-3,7,11-trimethyldodeca-1,6,10-trien-3-ol: 5 wt. %,
2-ethoxynaphthalene: 10 wt. %,
1-(3-methylbenzofuran-2-yl)ethanone: 5 wt. %,
(Z)-3,7-dimethylocta-2,6-dien-1-yl acetate: 5 wt. %,
(2E,6Z)-nona-2,6-dienal: 0.5 wt. %,
(Z)-non-6-enal: 0.5 wt. %,
(Z)-non-6-en-1-ol: 0.5 wt. %,
3-(4-(2-methylpropyl)-2-methylphenyl)propanal: 25 wt. %,
6-propyltetrahydro-2H-pyran-2-one: 1 wt. %,
1-(2-naphtalenyl)-ethanone: 10 wt. %,
4-(tert-butyl)cyclohexyl acetate: 50 wt. %,
5-heptyldihydrofuran-2(3H)-one: 25 wt. %,
3,7-dimethyloctan-1-ol: 10 wt. %,
2-phenylethyl acetate: 15 wt. %,
2,6,6-trimethylbicyclo[3.1.1]hept-2-ene: 2 wt. %,
6,6-dimethyl-2-methylenebicyclo[3.1.1]heptane: 2 wt. %,
(2E,5E)-5,6,7-trimethylocta-2,5-dien-4-one: 2 wt. %,
2,4,7-Trimethyl-6-octen-1-ol: 2 wt. %,
3-methylbut-2-en-1-yl acetate: 10 wt. %,
5-pentyldihydrofuran-2(3H)-one: 5 wt. %,
4-(4-hydroxyphenyl)butan-2-one: 5 wt. %,
dec-9-en-1-ol: 2 wt. %,
4-methyl-2-(2-methylprop-1-en-1-yl)tetrahydro-2H-pyran: 2 wt. %,
4-methyl-2-phenyl-3,6-dihydro-2H-pyran: 2 wt. %,
2,6,6-trimethylcyclohexa-1,3-dienecarbaldehyde: 0.5 wt. %,
4-(dodecylthio)-4-methylpentan-2-one: 0.5 wt. %,
2-methyl-3-[4-(2-methylpropyl)phenyl]propanal: 5 wt. %,
1-phenylethyl acetate: 5 wt. %,
(E)-2-((3,5-dimethylhex-3-en-2-yl)oxy)-2-methylpropyl cyclopropanecarboxylate: 5 wt. %,
1-methyl-4-propan-2-ylcyclohexa-1,4-diene: 5 wt. %,
2-(4-methylcyclohex-3-en-1-yl)propan-2-ol: 5 wt. %,
1-methyl-4-(propan-2-ylidene)cyclohex-1-ene: 15 wt. %,
3,7-dimethyloctan-3-ol: 50 wt. %,
1-(cyclopropylmethyl)-4-methoxybenzene: 10 wt. %,
(E)-tridec-2-enenitrile: 15 wt. %,
3-phenylbutanal: 5 wt. %,
3-(benzo[d][1,3]dioxol-5-yl)-2-methylpropanal: 5 wt. %,
(E)-4-methyldec-3-en-5-ol: 25 wt. %,
2-methoxynaphtalene: 15 wt. %,
cedar wood oil: 5 wt. %,
eucalyptus oil: 25 wt. %,
galbanum oil: 2 wt. %,
clove oil: 5 wt. %,
lavandin oil: 25 wt. %,
mandarin oil: 5 wt. %,
orange terpenes: 50 wt. %,
patchouli oil: 10 wt. %,
ylang oil: 5 wt. %.

4. The encapsulated composition according to claim 2, wherein each of the biodegradable ingredient(s) is present at a concentration equal to or higher than the minimum concentration of 0.01 wt.-%.

5. The encapsulated composition according to claim 1, wherein weight ratio of the core relative to the total weight of the capsule, namely the sum of the weight of the core and the weight of the shell, is at least 60 wt.-%.

6. The encapsulated composition according to claim 1, wherein the shell comprises a melamine-formaldehyde polymer.

7. The encapsulated composition according to claim 1, wherein the shell comprises a polyurea or polyurethane polymer.

8. The encapsulated composition according to claim 1, wherein the shell comprises a polymeric stabilizer that is formed by combination of a polymeric surfactant with at least one aminosilane.

9. The encapsulated composition according to claim 8, wherein the shell additionally comprises a polysaccharide.

10. The encapsulated composition according to claim 1, wherein the shell comprises a complex coacervate formed of at least one protein and at least one polysaccharide.

11. The encapsulated composition according to claim 10, wherein the shell is formed by cross-linking of the at least one protein with a first cross-linking agent, in order to form a simple coacervate, followed by the addition of the at least one polysaccharide to form a complex coacervate.

12. The encapsulated composition according to claim 1, wherein the shell comprises, in polymerized form, one or more monoethylenically unsaturated and/or polyethylenically unsaturated monomer(s).

13. A consumer product comprising an encapsulated composition according to claim 1.

14. A method of producing a consumer product, the method comprising the use of the encapsulated composition according to claim 1.

15. The encapsulated composition according to claim 1, wherein the perfume composition comprises at least two biodegradable ingredient(s).

16. The encapsulated composition according to claim 15, wherein the perfume composition comprises at least four biodegradable ingredient(s).

17. The encapsulated composition according to claim 16, wherein the perfume composition comprises at least eight biodegradable ingredient(s).

18. The encapsulated composition according to claim 17, wherein the perfume composition comprises at least 16 biodegradable ingredient(s).

19. The encapsulated composition according to claim 18, wherein the perfume composition comprises at least 32 biodegradable ingredient(s).

20. The encapsulated composition according to claim 19, wherein the perfume composition comprises at least 64 biodegradable ingredient(s).
